(19) United States
(12) Patent Application Publication
(10) Pub. No.: US 2005/0081441 A1
(43) Pub. Date: Apr. 21, 2005

(54) Planter apparatus

(76) Inventor: John C. Mantovani, Suwanee, GA (US)

Correspondence Address: GARDNER GROFF, P.C., 2018 POWERS FERRY ROAD, SUITE 800, ATLANTA, GA, 30339, US

(21) Appl. No.: 10/896,616

(22) Filed: Jul. 22, 2004

Related U.S. Application Data
(60) Provisional application No. 60/489,369, filed on Jul. 23, 2003.

(51) Int. Cl. A01G 9/02

(52) U.S. Cl. 47/67

(57) ABSTRACT

A plant planter for maintaining the health of container grown plants and includes a container adapted for containing soil and a plant planted in the soil. Further, the planter includes at least one sensor for monitoring at least one growing condition. The planter is further responsive to an indication from the sensor of the monitored growing conditions for effecting a growing condition. The growing condition can be further effected based on the species of the plant. In addition, a plurality of planters can be included in a system for maintaining a plurality of plants in which each planter can be programmed to effect growing conditions based on the species of the plant planter in the respective containers. Moreover, the system of planters can be adapted for communication therebetween for enabling effective use of shared resources.

### CROSS-REFERENCE TO RELATED APPLICATION

This application claims the benefit of U.S. Provisional Patent Application Ser. No. 60/489,369, filed Jul. 23, 2003, which application is incorporated herein by reference in its entirety for all purposes.

### TECHNICAL FIELD

The present invention relates generally to plant planters and, more particularly to an apparatus and system for providing automated growth conditioning to container grow plants.

### BACKGROUND OF THE INVENTION

When plants are grown in planters, the proper upkeep required to keep the plants growing and healthy is critical to the life of the plant. For example, if the plant is not watered when the soil dries out then the plant will dehydrate, wither and eventually die. Similarly, it can be detrimental to the health of the plants in the planter, if the planter is watered too often or too heavily at each application. Thus, the proper upkeep of the planter should include providing moisture to the soil in the planter. For optimum upkeep of the planter moisture should be provided at a schedule that optimizes the growth and health of the plants.

A plants growth is dependent on its growing conditions and includes many different factors. Some of the factors that directly affect a plants growth include: soil moisture, light intensity, soil nutrient levels, soil type and chemistry, air temperature, air humidity, and soil temperature. All of these factors contribute to the health and ultimate successful growth or the death of the plant. In addition, the optimization of these factors for a plant is also dependent on the plant species. Some plant species prefer to have their soil moist all the time and suffer if the soil moisture gets too dry between watering while other plant species prefer moderate soil moisture levels and suffer if the soil moisture does not somewhat dry out between watering. Likewise, some plant species prefer shade while others require full sun.

The proper upkeep of the container grown plants starts with the proper soil selection and container for the plant used in the planter and with the physical placement of the planter into the landscape. The site for the planter should be selected to provide the required climate for the plants used in the planter and to optimize its exposure to the sun. Once the planter is placed into the landscape, its growth is dependent on regular upkeep of the planter including watering and fertilization. The watering schedule should match the plant species preferred soil conditions to optimize the growth and health of the plants. Likewise, the fertilization schedule should provide the optimum nutrient levels according to the plant species.

In today's fast paced world where spare time is hard to find, many people find container plant growing to be unsuccessful and/or to time consuming. Further more, many people do not have the horticultural knowledge needed to successfully grow plants in containers. So, even if they have the time for the proper upkeep, they may not understand how to optimize the schedule of the upkeep and end up hurting the plant by watering to often or not supplying the required nutrients for the plant.

In contrast, beauty in the landscape seems to be a growing trend in both residential and commercial applications. The addition of container grown plants to the landscape can be one way to quickly add to the beauty of the landscape. Most people like the look of a well grown flowering basket and would love to have their front porch proudly displaying several flowering planter baskets. But the time and effort required for the upkeep of the planter, keeps them from having flowering planters. Or, they avoid container planting because they have previously tried container planting with unsuccessful results.

### SUMMARY OF THE INVENTION

Briefly described, in a first preferred form the present invention provides a plant planter apparatus to maintain the health of container grown plants. An embodiment according to the invention includes a container adapted for containing soil and a plant planted in the soil. The apparatus also includes at least one sensor for monitoring at least one growing condition parameter for the plant and further for generating a growing condition parameter signal. The at least one sensor is in sensory communication with one of the soil and plant. The apparatus further includes a controller for controlling the at least one growing condition in response to the growing condition parameter signal generated by the at least one sensor and an effector coupled with and controlled by the controller for controlling at least one growing condition.

The growing condition can be water needs, temperature, soil fertilization, illumination, and plant orientation. For example, the sensor can determine the soil's moisture content whereby the effector is controlled to provide water to the soil to achieve a desired moisture content. Further, the sensor can determine soil temperature whereby the effector is controlled to provide heat to the soil to achieve a desired soil temperature. The sensor can also monitor soil fertilization whereby the effector is controlled to provide a desired level of fertilization. Further, the sensor can include two or more sensors for measuring at least two growing conditions.

An aspect of the present invention takes advantage of the recognition by the inventor that different species of plants have different growing condition requirements for optimum health and/or growth. As such, the controller can include an interface for receiving user information about the particular type of plant being planted in the container wherein the controller is adapted to utilize this information for controlling at least one of the growing conditions. Moreover, one way of carrying out the present invention is to utilize current information, or the most recent information from sensor determination to effect control. Alternatively, current information and historical information from sensor determination can be utilized to effect control.

Preferably, the container is further adapted to be suspended from an overhead housing which is adapted to house the controller. Moreover, the overhead housing includes a drive mechanism for rotating the plant planter for providing control of the angular position of the plant for enabling uniform light exposure. Alternatively, the container can be adapted to rest on a base or pedestal which is adapted to house the controller. Moreover, a drive mechanism for rotating the plant planter for providing control of the angular position of the plant for enabling uniform light exposure can be included in the base.

In another form according to the invention a plurality of containers each adapted for containing soil and a plant planted in the soil comprise a planter system. Each container includes at least one sensor for monitoring at least one growing condition parameter for the plant and further for generating a growing condition parameter signal. Each planter in the system monitors and controls its individual planter with water, electricity, and fertilizer being applied to each planter from common system resources. The system also includes a controller for monitoring and controlling the system resources. Another aspect of the present invention takes advantage of the recognition by the inventor that different species of plants have different growing condition requirements for optimum health and/or growth. As such, the system enables a unique maintenance schedule for each container via the controller.

### BRIEF DESCRIPTION OF THE DRAWINGS

FIG. 1 is a side view of the Planter Apparatus illustrating the Overhead Module and the Soil Container Assembly in accordance with exemplary embodiments of the present invention;

FIG. 2 illustrates a system utilizing a plurality of Planter Apparatuses in accordance with exemplary embodiments of the present invention;

FIG. 3 is a side cross-sectional view of the Planter Apparatus in accordance with exemplary embodiments of the present invention;

FIGS. 4A-4C give a top view, side view, and bottom view of the Overhead Module in accordance with exemplary embodiments of the present invention;

FIGS. 5A-5B illustrate the Overhead Module giving a side cross-sectional view (along the line A-A) and a transparent bottom view of the Housing's lower compartment in accordance with exemplary embodiments of the present invention;

FIGS. 6A-6B is a top view of the Overhead Module with the Overhead Mounting Plate removed to illustrate its upper compartment, a side cross-sectional view (along line A-A) is also shown in accordance with exemplary embodiments of the present invention;

FIG. 7 is an enlarged side cross-sectional view (along line A-A) of the Overhead Module in accordance with exemplary embodiments of the present invention;

FIG. 8 is a enlarged side cross-sectional view (along line C-C) of the Overhead Module in accordance with exemplary embodiments of the present invention;

FIGS. 9A-9B detail the Overhead Module's Overhead Mounting Plate in accordance with exemplary embodiments of the present invention;

FIGS. 10A-10B illustrate the assembled Base Plate Sub-Assembly of the Overhead Module in accordance with exemplary embodiments of the present invention;

FIGS. 11A-11B illustrate the assembled Housing Master Sub-Assembly of the Overhead Module in accordance with exemplary embodiments of the present invention;

FIGS. 12A-12B illustrate the Rotating Module Sub-Assembly which is a component of the Base Plate Sub-Assembly in accordance with exemplary embodiments of the present invention;

FIGS. 13A-13B illustrate the Rotating Bearing Sub-Assembly which is a component of the Rotating Module Sub-Assembly in accordance with exemplary embodiments of the present invention;

FIGS. 14A-14B illustrate the Rotating PCB Sub-Assembly which is a component of the Rotating Module Sub-Assembly in accordance with exemplary embodiments of the present invention;

FIGS. 15A-15B illustrate the Master PCB Sub-Assembly which is a component of the Housing Master Sub-Assembly in accordance with exemplary embodiments of the present invention;

FIGS. 16A-16B illustrate the Internal Water System which is a component of the Master PCB Sub-Assembly in accordance with exemplary embodiments of the present invention;

FIGS. 17A-17B illustrate the Housing Sub-Assembly which is a component of the Housing Master Sub-Assembly in accordance with exemplary embodiments of the present invention;

FIGS. 18A-18B give a top view and a side cross-sectional view (along line B-B) of the Soil Container Assembly and illustrates the Soil Probe Assembly in accordance with exemplary embodiments of the present invention;

FIG. 19 is a block diagram of 2-wire control electronics for the Planter Apparatus in accordance with exemplary embodiments of the present invention;

FIG. 20 is a schematic diagram of the Communication Channel for the HPA system illustrated in FIG. 2 in accordance with exemplary embodiments of the present invention;

FIG. 21 illustrates the input and output connections to the Span Control Unit in accordance with exemplary embodiments of the present invention;

FIG. 22 is a block diagram of the electronics of the Span Control Unit in accordance with exemplary embodiments of the present invention.

FIG. 23 is a block diagram of 4-wire control electronics for the Planter Apparatus in accordance with exemplary embodiments of the present invention;

FIG. 24 is a cross-sectional view of another overhead module in accordance with exemplary embodiments of the present invention;

FIG. 25 illustrates another system for a plurality of Planter Apparatuses in accordance with exemplary embodiments of the present invention.

FIG. 26 is a schematic diagram of a communication channel for the system in FIG. 25 in accordance with exemplary embodiments of the present

The following provides a list of Reference Numerals Utilized in the Drawings.

| | |
|---|---|
| 1 | Planter Apparatus |
| 2 | Overhead Module Assembly |
| 3 | Soil Probe Assembly |
| 4 | Soil Container Assembly |
| 5 | Overhead Support Structure |
| 10 | Housing |
| 11 | Housing Base Plate |
| 12 | Motor |
| 13 | Master PCB |
| 14 | Spur Gear |
| 15 | Rotating PCB |
| 16 | Internal Gear |
| 17 | Stand-Off --- Mounting Plate-to-PCB |
| 18 | Rotating Mounting Plate |
| 19 | Lazy Susan Bearing |
| 20 | Water Valve |
| 21 | Span Line Water Connector - Input |
| 22 | Water Tubing - Output Connector to Valve Always-On Port |
| 23 | Water Tubing - Input Connector to Valve Input Port |
| 24 | Water Tubing - Sprinkler Head to Valve Normally-Closed Port |
| 25 | Sprinkler Head |
| 26 | Span Line Water Connector - Output |
| 27 | Spring Mount Electrical Stand-Off Connectors --- Rotating PCB |
| | to Rotating Transformer PCB |
| 28 | Rotating Transformer PCB |
| 29 | Support Ligaments for Soil Container |
| 30 | Overhead Mounting Plate |
| 31 | Shoulder Head Pin --- Housing to Key Hole Slots in Overhead |
| | Mounting Plate |
| 32 | Center Head Pin --- Housing to Center Alignment Slot in |
| | Overhead Mounting Plate |
| 33 | Stand-Off --- PCB to Internal Gear |
| 34 | Threaded Stud on Rotating Mounting Plate |
| 35 | Housing Drain and Span Line Access Channels |
| 36 | Screws --- Base Plate to Housing |
| 37 | Screws --- Master PCB to Housing |
| 38 | Screws --- Base Plate to Lazy Susan Bearing |
| 39 | Screws --- Rotating Mounting Plate to Lazy Susan Bearing |
| 40 | Nuts --- Internal Gear to Rotating PCB to Rotating Mounting |
| | Plate |
| 41 | Key Hole Slots in Overhead Mounting Plate |
| 42 | Center Alignment Hole in Overhead Mounting Plate |
| 43 | Electrical Connector For Soil Probe |
| 44 | Electrical Connectors For Span Line Input Port |
| 45 | Electrical Cable Harness for Soil Probe |
| 46 | Support Ligament Mounting Links |
| 47 | Central Clearance Hole in Rotating Mounting Plate |
| 50 | Soil Container |
| 51 | Soil Container Liner & Insulator |
| 52 | Soil Mulch & Insulator |
| 53 | Soil Moisture Probe A |
| 54 | Soil Moisture Probe B |
| 55 | Soil Heating Element |
| 56 | Soil Temperature Probe |
| 57 | Soil Probe PCB |
| 58 | Soil Probe Conformal Coating |
| 59 | Soil |
| 60 | Master PCB Sub-Assembly |
| 61 | Rotating PCB Sub-Assembly |
| 62 | Soil Probe PCB Sub Assembly |
| 63 | Electronic Components on the Master PCB |
| 64 | Electronic Components on the Rotating PCB |
| 67 | User Interface - Switch Panel |
| 68 | User Interface - Display |
| 69 | Central Clearance Hole in Housing Base Plate |
| 70 | Housing Master Sub-Assembly [(74) + (60) + (36)] |
| 71 | Rotating Bearing Sub-Assembly [(19) + (18) + (39)] |
| 72 | Rotating Module Sub-Assembly [(71) + (61) + (16) + (17) + |
| | (33) + (40)] |
| 73 | Base Plate Sub-Assembly [(72) + (11) + (38)] |
| 74 | Housing Sub-Assembly [(10) + (21) + (26) + (44) + (31) + (32)] |
| 75 | Internal Water System [(20) + (22) + (23) + (24)] |
| 101 | Span Line Electrical Input Signal |
| 102 | Span Line Electrical Output Signal |
| 103 | Water Supply Input |
| 104 | Water Supply Output |
| 110 | Span Line Input Transformer |
| 111 | Span Line Input Hybrid |
| 112 | Span Line Down-Stream System Communication Channel |
| 113 | Span Line Down-Stream System Receive Channel |
| 114 | Span Line Up-Stream System Transmit Channel |
| 115 | Master Microprocessor |
| 116 | Span Line Up-Stream System Communication Channel |
| 117 | Span Line Up-Stream System Receive Channel |
| 118 | Span Line Down-Stream System Transmit Channel |
| 119 | Span Line Output Hybrid |
| 120 | Span Line Output Transformer |
| 121 | Span Line Power Converter |
| 122 | Supply Voltage for Master PCB |
| 123 | Electrical Ground Reference for Master PCB |
| 124 | Master PCB Rotating Communication Channel |
| 125 | Master PCB Rotating Transmit Channel |
| 126 | Master PCB Rotating Receive Channel |
| 127 | Power Oscillator |
| 128 | Master PCB Hybrid |
| 129 | Display Lighting Control Electronics |
| 130 | Display Light Bulb/Fixture |
| 131 | Motor Control Electronics |
| 132 | Temperature Detector Electronics for Internal Temperature |
| 133 | Temperature Probe for Overhead Module's Internal Temperature |
| 134 | Heater Control Electronics for Internal Heater |
| 135 | Internal Heater Element |
| 136 | Sprinkler Control Electronics |
| 137 | Flash Memory For Master Microprocessor |
| 149 | Fixed Coils for Rotating Transformer |
| 150 | Rotating Coils For Rotating Transformer |
| 151 | Rotating PCB Hybrid |
| 152 | Rotating PCB Rotating Communication Channel |
| 153 | Rotating PCB Rotating Receive Channel |
| 154 | Rotating PCB Rotating Transmit Channel |
| 155 | Local User Interface |
| 156 | Local User Interface - Display |
| 157 | Local User Interface - Switch panel |
| 158 | Flash Memory For Rotary Microprocessor |
| 159 | Rotary Microprocessor |
| 160 | Rotating PCB Power Converter |
| 161 | Supply Voltage For Rotating PCB |
| 162 | Electrical Ground Reference for Rotating PCB |
| 163 | Moisture Detector Electronics |
| 164 | Humidity Detector Electronics |
| 165 | Temperature Detector Electronics For Outside and Soil |
| | Temperatures |
| 166 | Humidity Probe |
| 167 | Outside Air Temperature Probe |
| 168 | Heater Control Electronics For Soil Heater |
| 170 | Sun Light Detector Electronics |
| 171 | North, South, East, and West Photo Detectors |
| 181 | Split Center Taps of the Span Line Input Transformer |
| 182 | Split Center Taps of the Span Line Output Transformer |
| 200 | Span Control Unit Module (SCU) |
| 201 | Household 120 VAC Input Voltage |
| 202 | Fertilizer Supply |
| 203 | Household Water Supply Input |
| 204 | Electrical Output To Span Line |
| 205 | Span Line Water Feed |
| 206 | Span Water Line Tubing |
| 207 | Electrical Span Line Cabling |
| 208 | Personal Computer |
| 209 | SCU Span Line Down-Stream System Communication Channel |
| 210 | SCU Span Line Up-Stream System Communication Channel |
| 211 | SCU Up-Stream System Receive Channel |
| 212 | SCU Down-Stream System Transmit Channel |
| 213 | SCU Hybrid |
| 214 | SCU Span Line Output Transformer |
| 215 | SCU Electrical Connector For Span Line |
| 216 | SCU Power Converter |
| 217 | Supply Voltage for SCU Electronics |
| 218 | Supply Voltage for Span Power Feed |
| 219 | Span Power Monitor Electronics |
| 220 | Input Connector for 120 VAC |
| 221 | SCU Microprocessor |
| 222 | Water Feed Control Electronics |
| 223 | SCU User Interface Electronics |
| 224 | SCU Local User Interface |
| 225 | USB Port |
| 226 | USB Connector |
| 227 | Fertilizer Feed Control Electronics |
| 228 | Connector for Fertilizer Source Input |
| 229 | Fertilizer Supply Tubing (Input to Mixer) |
| 230 | Connector for Household Water Supply Input |
| 231 | Water Supply Tubing (Input to Water Valve) |
| 232 | Span Line Master Water Cut-Off Valve |
| 233 | Water Tubing (Valve to Mixer) |
| 234 | Mixer (Fertilizer & Water) |
| 235 | Mixed Water Tubing (Mixer to Pressure Regulator) |
| 236 | Water Pressure Regulator |
| 237 | Span Out Tubing (Pressure Regulator to Output) |
| 238 | Connector for Span Line Water Supply Output Port |
| 239 | Flash Memory For SCU Microprocessor |
| 240 | Span Ground Fault Detector Electronics |
| 241 | Split Center Taps of the SCU Span Line Output Transformer |
| 242 | SCU User Interface Display |
| 300 | Pedestal Planter Apparatus |
| 301 | Electrical Span Input Port |
| 307 | 4-Wire Electrical Span Line |
| 312 | System Communication Channel |
| 313 | System Communication Channel Receiver |
| 314 | System Communication Channel Transmitter |
| 321 | Real Time Clock Electronic Module |
| 322 | Real Time Clock Battery |
| 324 | Fixed IR Communication Channel |
| 325 | Fixed IR Transmit Illumination Field |
| 326 | Fixed IR Receive Illumination Field |
| 328 | Floating Fixed Transformer PCB |
| 329 | Spring Mount Electrical Stand-Off Connector Floating PCB to |
| | Fixed PCB |
| 330 | Rotating Transformer |
| 331 | Fixed Ferrite Half of Rotating Transformer |
| 332 | Rotating Ferrite Half of Rotating Transformer |
| 345 | 2-Wire Pair for Bi-Directional System Communication Channel |
| 346 | 2-Wire Pair for 12 VAC Power Input |
| 352 | Rotating IR Communication Channel |
| 353 | Rotating IR Receive Illumination Field |
| 354 | Rotating IR Transmit Illumination Field |
| 361 | Three Output Supply Voltage for Rotating PCB |
| 371 | Metallic Clear Stand-Off Rotating Mounting Plate to Lazy Susan |
| | Bearing |
| 372 | Metallic Threaded M/F Stand-Off Base Plate Sub-Assembly to |
| | Housing |
| 373 | Metallic Threaded F/F Stand-Off Master PCB Sub-Assembly to |
| | Housing |
| 374 | Threaded Eye-Bolt Hanger |

### DETAILED DESCRIPTION OF PREFERRED EMBODIMENTS

The presently described planter apparatus, can eliminate much of the time involved by the plant container owner for the proper upkeep of the planter. The Planter Apparatus will enable people to have container plants without much of the work required For the proper upkeep of the plants. Similarly, by automating the upkeep of the planter The invention can be programmed to provide optimum growing conditions of the planter Dependant on the type of plants actually planted into the planter.

The present invention is expanded to relate to a system, which can be used to automatically provide the optimum growing conditions for a plurality of these planter apparatuses. Each apparatus provides upkeep for one individual planter and individually schedules this upkeep based on the requirements of its individual planter environment and the type of plants it is supporting. Each apparatus in the system communicates with all other apparatuses in the system and share common resources like electrical power, water, and fertilizer.

More particularly, each apparatus contains electronic circuitry that includes a microprocessor connected to a series of sensors and control devices that are used to independently optimize the growing condition for the species of plants in its container. The apparatuses' sensors allow it to monitor the actual environment of the planter as well as the condition of the planter's soil. For example, the apparatus will monitor the present air temperature and humidity to track expected evaporation rate, and the apparatus will monitor the soil moisture content to determine when to water the container. The control devices allow the apparatus to perform the upkeep maintenance on the planter. As an example, the apparatus can operate its control valve to water the container.

The initial embodiment of the invention is used to automate the optimal growing conditions for an outdoor hanging container type of planter. However, the concept of the Planter Apparatus device is also valid for other types of planters. The invention is easily adapted to planter types that are placed on horizontal surfaces like a table or window ledge rather than being suspended from above. The concept of the automated Planter Apparatus is valid for both indoor planters and outdoor planters. The Planter Apparatus System of planters described in this invention, may include a number of different Planter Apparatuses types all working together sharing the common resources provided by the system span lines.

The electronics, the sensors, and the control devices used in each apparatus optimize the soil moisture cycle in the planter and are used to provide an optimized soil moisture cycle for the specific type of plants growing in its individual planter. For example, the moisture cycle required for one type of plant's optimum growth may be detrimental to another plant species. An extreme example of this is the contrasting water cycle requirements for a cactus versus that of a water lily. The present invention will sense the soil moisture level in its planter and only add additional moisture when the moisture level in its container drops below a specified level. In this way, it will be able to optimize the water cycle for its individual planter and for the actual type of plants contained in it.

The automated water systems used today for container plants are typically set to provide moisture on a periodic time base system (e.g. water for 15 minutes once every two days). This type of watering system has many disadvantages for container planting. Watering on a fixed schedule will often result in over or under watering for a planter. For example an outside container may require watering as often as twice a day in the heat of the dry summer months. While during the cooler months, watering more than once or twice a week will result in over-watering for many types of plants. In addition, the plants actual exposure to sunlight and the plant size also effect how quickly a containers soil moisture level falls. So, even if two different containers have the same type of plants growing in them their optimum water cycle may be different if one of the planters is in the shade more than the other. Automated watering systems used today typically provide water to several hanging baskets with one valve providing all the baskets with identical watering cycles. The present invention provides for a soil moisture cycle on an individual planter basis based on actual measured soil levels.

In addition, the apparatus uses its electronics, sensors, and control devices to help optimize growth by providing for uniform exposure of the plants in its container to its source of light, typically the sun. It is common for plants grown in containers to get lopsided in growth when the container does not receive even exposure to light. A typical example of this is for a planter, which is hanging from the eve of the house. The front of the planter facing away from the house receives the majority of the exposure to the daily sun while the house wall shades the back of the planter. As the plants grow in the planter the plant foliage facing the front grows quicker and larger and eventually provides shade to the plant foliage facing the back of the planter making things even worse. In this manner, the plant becomes lopsided with all the growth out of the front of the planter. In order to avoid this unattractive plant growth, the planter can be rotated periodically to provide an even exposure to all sides of the planter over time. The present invention detects sun light levels in various directions of the planter and can rotate the planter periodically or on a continuous basis to provide even exposure to all sides of the container.

An additional benefit of the rotational characteristics of the apparatus is evident when one considers the display characteristics of the planter from various directions. As discussed above, in many applications hanging planters need to be rotated regularly for attractive symmetrical growth. If the planter contains flowering plants and it is not rotated frequently, it is common that most if not all of the flowers will be pointing away from the house and toward the direction of maximum exposure to the sun. So, if this hanging planter is placed outside a window and it is viewed from within the house through the window, most of the flowers are pointing away and are not visible from inside. Thus, the attractiveness of this planter is best viewed from the outside.

However, since the planter in the apparatus of this invention is rotated such that all sides of the planter receive equal amounts of exposure to the sun, the plant grows symmetrically. Flowering plants grow with an even distribution of flowers pointing in all directions. So when a hanging planter apparatus of this invention is viewed from within the house through the window, the plant is very attractive with symmetrical growth. For flowering plants, there are an equal amount of flowers pointing toward the window as there are flowers pointing away from the house. Since the ultimate goal of container growing is to maximize its attractiveness in the landscape, this invention can be used not only to automate the upkeep of the planter and to optimize the upkeep schedule based on plant species but it can also be used to help to optimize the attractiveness of its planter in the landscape.

The electronics, the sensors, and the control devices used in each apparatus can also provide optimal soil temperature during cold growing conditions. Container grown plants are much more susceptible to cold weather since the soil temperature is much quicker to react to air temperature changes than the temperature of the ground soil which reacts very slowly. During the spring and fall seasons the air temperature changes dramatically from day to night and can easily change from freezing temperatures at night to mild temperatures in the day. During the same days the earth's soil temperature just a few inches below the ground varies less than a degree or two from day to night. In contrast, the soil temperature in a planter quickly tracks the air temperature. The soil temperature of a container can easily dip below freezing when air temperatures fluctuate heavily in the spring and fall seasons. This puts plants grown in containers at a disadvantage over those grown in the ground.

The apparatus of this invention can help to minimize the above disadvantage by automatically adding heat to the soil when the air temperature falls. It can use this soil temperature control as an advantage to increase the length of the life cycle and/or the flowering cycle for various types of plants. One example of this is by providing heat to the container soil early in the spring when air temperatures vary considerably. This added heat can maintain soil temperatures at an optimal temperature point to promote seed germination and/or early plant growth. With this advantage, a planter could be started from seed earlier in the growing season than possible with typical planters used today.

A second example would be that for some specific plant types like the pansy (Viola wittrockianna) that can tolerate freezing air temperatures. In southern areas of the USA it is common for homeowners and commercial office owners to plant pansies in the landscape in ground based flower beds during the fall when the normal summer annuals are giving way to frost at night. Pansies can be grown in mild winter areas through the winter and can provide color to the landscape during most if not all of the winter months. While pansies are commonly grown in the ground they are rarely grown in containers. This is partially due to the soil temperature variation of the containers soil as discussed above. While pansy foliage can withstand temporary durations of freezing temperatures, the amount of flowers produced is directly related to the soil temperature. So container-grown pansies do not bloom well if at all during the colder temperature months since the containers soil is much colder than the soil in the ground. This invention can maintain soil temperature throughout the coldest months to promote blooming of pansies grown in the apparatus.

Further, the electronics, the sensors, and the control devices are used in each apparatus to provide automated and optimal fertilization-feeding schedule for the plant. The optimal fertilization schedule for various plant species vary since some plants respond well to heavy fertilization while others require minimal fertilization. Since the apparatus of this invention works on an individual planter basis it can fertilize according to the needs of its specific plant type. In this way a system of planters can be used in the landscape and all of the various plant types are provided with individual optimal nutrient feeding.

Finally, the electronics, the sensors, and the control devices used in each apparatus can be configured to provide many different types of attractive and functional display conditions for the planter. The fact that the planter has electricity and a series of sensors and control devices make these types of display enhancements inexpensive and easy to actualize. For example the first embodiment of this invention discussed below provides a light fixture that can be used to illuminate the plant during the night to highlight it in the landscape. In addition, its rotational mechanism can be used to provide a slow or moderate speed continuous rotation of the planter to draw attention to the planter in the landscape or garden. Other examples of increased attractiveness to the planter are almost limitless and include decorations to the outside of the container and/or apparatus housing. Various approaches could include fiber optic illumination techniques, animation techniques, water fountain type features, color enhancement or variation, etc.

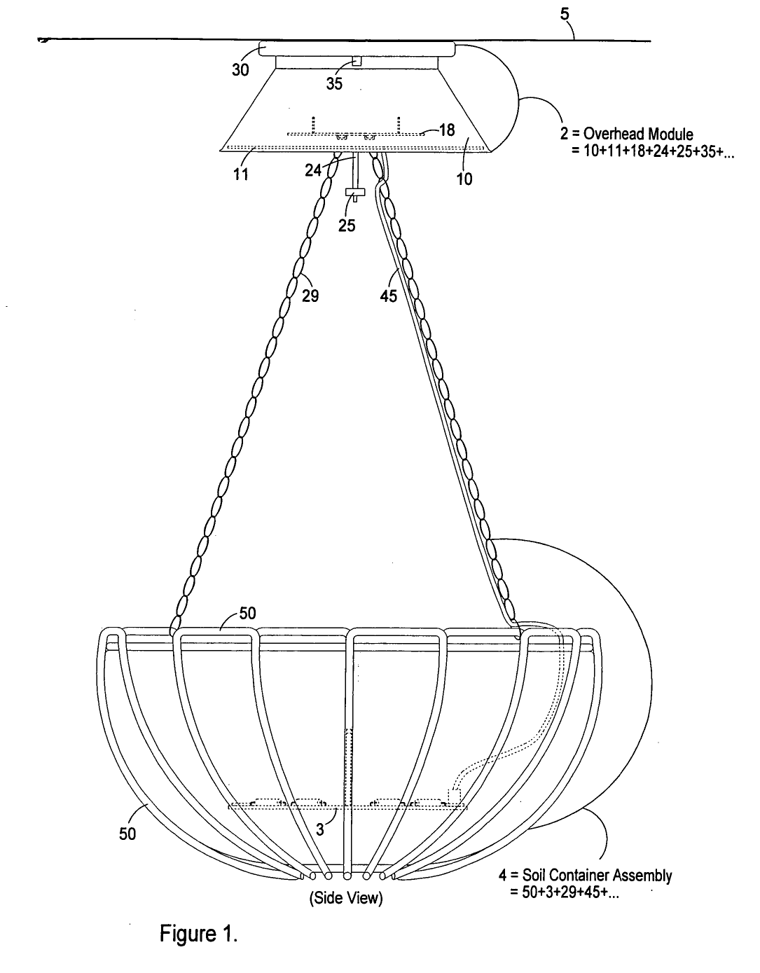

A simplified illustration of the hanging planter embodiment of the apparatus of the invention is given in FIG. 1. In this embodiment, the planter apparatus is composed of a Module Assembly 2 and a Soil Container Assembly 4.

The Module Assembly 2 is contained in a weather resistant housing 10 and is used to protect and contain the apparatuses' electronics and to provide external connections for the span's electrical line, the span's water feed line, the hanging basket Soil Container Assemblies' support ligaments 29, the soil probe's cable harness 45, and the overhead mounting plate 30. The housing's base plate 11 features and supports a centrally located rotating mounting plate 18 to support the top of the hanging basket's support ligaments 29. The mounting plate 18 can be rotated by means of a motor and drive gears built internal to the housing. In another embodiment, the module assembly 2 and soil container assembly 4 are arranged as a pedestal planter. More specifically, the soil container assembly 4 rests on the module assembly 2 which is configured as a base for receiving the soil container assembly 4. In a further embodiment, the soil container assembly 4 and the module assembly 2 are integrated as a single unit. In the pedestal arrangement, the soil container 4 and rotating mounting plate 18 are associated such that rotation is enabled with the soil container 4 supported by the module assembly 2. Further, the water tubing 24 or other similar water directing device is routed such that water is disposed in the soil container 4 while the flow is controlled via the module assembly 2. The description hereinafter is specific to the hanging planter embodiment, however it also applies for the pedestal planter arrangement.

The rotating mounting plate 18 has on opening which is centrally located which enables the water tubing 24 for the external sprinkler 25 to pass through. This centrally located hole allows the hanging Soil Container Assembly 4, which is supported from the hanging basket's support ligaments (chains) 29 and rotating mounting plate 18, to rotate around the stationary water feed line 24 for the sprinkler head 25. Also mounted on the rotating mounting plate is an electrical connector that is used for wiring leads 45 to the soil probe 3. The soil probe is buried into the soil in the container 50 and rotates with it. The overhead module is mounted to an overhead support structure 5 (e.g., the overhang of the house) using the overhead mounting plate 30.

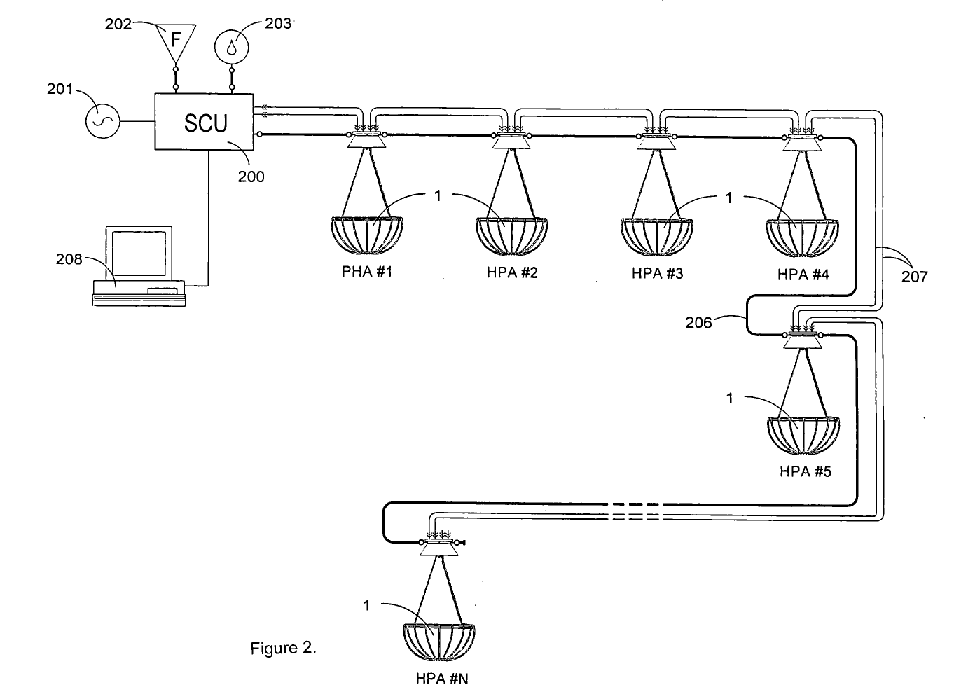

FIG. 2 provides an illustration of a system composed of a plurality of Hanging Planter Apparatuses (HPA) in accordance with exemplary embodiments of the present invention. The system can include one or multiple HPA. In the system illustrated in FIG. 2, there are “N” apparatuses 1 working on the span and there is a Span Control Unit 200 sourcing the resources to the system span lines.

Each HPA of the system is electrically powered in parallel from the Span Control Unit (SCU) 200 with a 2-wire cable for the electrical span line 207. The 2-wire span line can not only provide power to each apparatus, but can also provide a transmission line for a communications channel that enables the apparatuses to communicate with each other and with the SCU. The apparatuses in the system share a common source of water 203 and fertilizer 202 and are connected to the water and fertilization source at the SCU through the water feed line 206 in a parallel manner similar to the power connection. The parallel connection for power and water for each apparatus helps ensure the reliability of the system.

Although the HPA are supplied power and water from the span in a parallel mode, they are installed into the system in a series type manner. Each apparatus has an input connection for the electrical and water span lines. Similarly, each apparatus has an output connection for the electrical and water span lines. The series type connections to the HPA simplify the installation of the system and provides for easy expansion. Wiring and tubing connection internal to each HPA further provides for the parallel connections for the span power and water feed.

The Span Control Unit (SCU) 200 provides a power converter function by transforming the high voltage 120 VAC household power 201 to a low voltage feed for the electrical span line 207. A low voltage feed is used for the powering on the span line due to the close proximity of water in the apparatus and to ensure compatibility with safety requirements. The SCU can include ground fault detection on the span line and monitor the actual versus maximum available power on the span. Since the SCU unit communicates with each individual planter apparatus in the system it can approximate the expected power requirements on the loop and compare it to actual. This comparison allows the SCU to detect faults on the electrical span and/or cut-off power if hazardous conditions are detected. In addition, if the cumulative power required on the span exceeds the maximum achievable power, the SCU can temporarily delay the request of an individual apparatus for a task that requires increased power. For example, the SCU can tell individual planters to water on separate time frames rather than letting a large number all water at the same time. Another example would be for the SCU to limit the number of apparatuses that are in an active soil heat cycle.

The SCU can also provide pressurized water and fertilizer to the water feed line of the system. It provides a pressure regulator function to convert the varying pressure of the household water 203 to the regulated pressure on the water span line. When requested by a planter apparatus the SCU can also add fertilization to the water supplied in the water feed line. Again since the SCU is communicating with all of the apparatuses it can provide a policing function to request for watering. In this manner it can limit the number of planters watering at any particular time so the pressurized water feed does not exceed the flow capacity of the water span feed line. In addition, if no apparatuses are in the watering mode and the SCU detects water flow in the span, it can provide a master emergency cut-off of the water flow to the span line.

The SCU also provides a connection for an optional personal computer. This connection enables SW running on the PC to extract monitored statistics from each apparatus to the PC. This enables the planter's owner to monitor the moisture content, air and soil temperatures, fertilization history, etc. for each individual planter from his computer terminal. In addition, this connection of the SCU to the personal computer can enable firmware upgrades to be down loaded to the planters. Since personal computers are commonly and easily connected to the Internet, distribution of these firmware upgrades from the manufacture to the planter owner is easily and inexpensively implemented.

Hanging Planter Apparatus

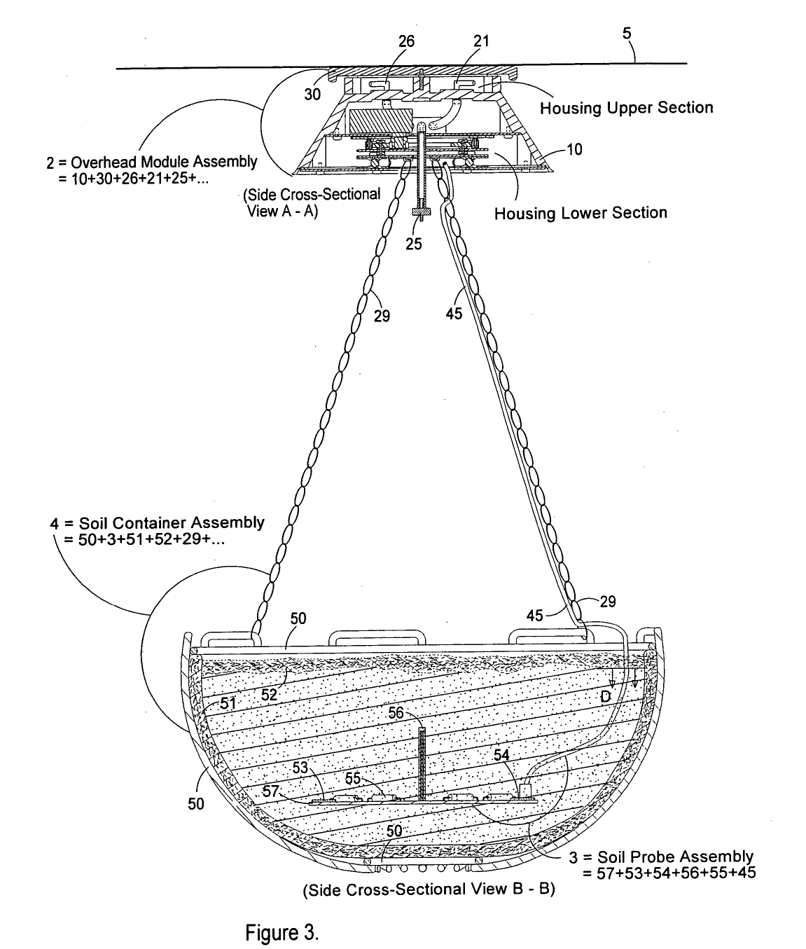

Referring now to the FIGS. 3-19, which depicts a first embodiment of the automated planter apparatus. This first embodiment of an automated planter apparatus is used to optimize the growing conditions for plants that are planted in its hanging basket style soil container; this specific devise is referred to as an Hanging Planter Apparatus (HPA). The Hanging Planter Apparatus automates much of the upkeep required to optimize the planters growing conditions. Examples of automated feature of the HPA include moisture control, fertilization control, angular position control, and temperature control. The automation of the HPA minimizes the amount of time the owner of the HPA needs to spend on upkeep of the plants in the HPA's soil container. In addition, the HPA can optimize the schedule of this automation based on the plant species minimizing the horticultural knowledge required by the owner.

After the initial planting of the plants and set-up for the HPA system, the planters operate fairly autonomously and the owner upkeep is greatly reduced from that required for traditional planters used today. Thus, rather than the daily maintenance normally required to keep traditional hanging planters healthy and growing, the maintenance required for the HPA would be cut to occasional inspection of the planters. Upkeep of the HPA is primarily limited to possible plant grooming requirements to maintain the plant's size/shape or flower de-heading, if required based on the plant species grown. Additional upkeep may include plant inspection/control for dieses or pest.

Physical Construction of the HPA

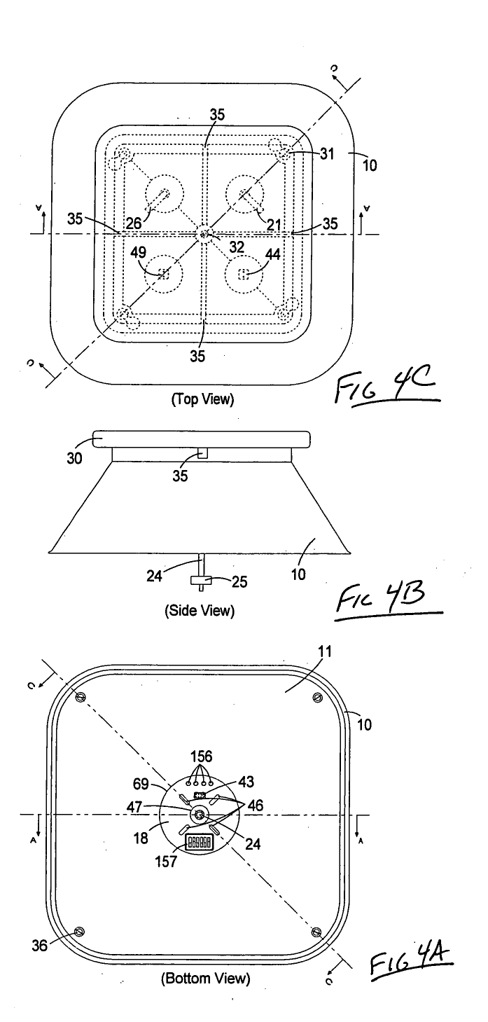

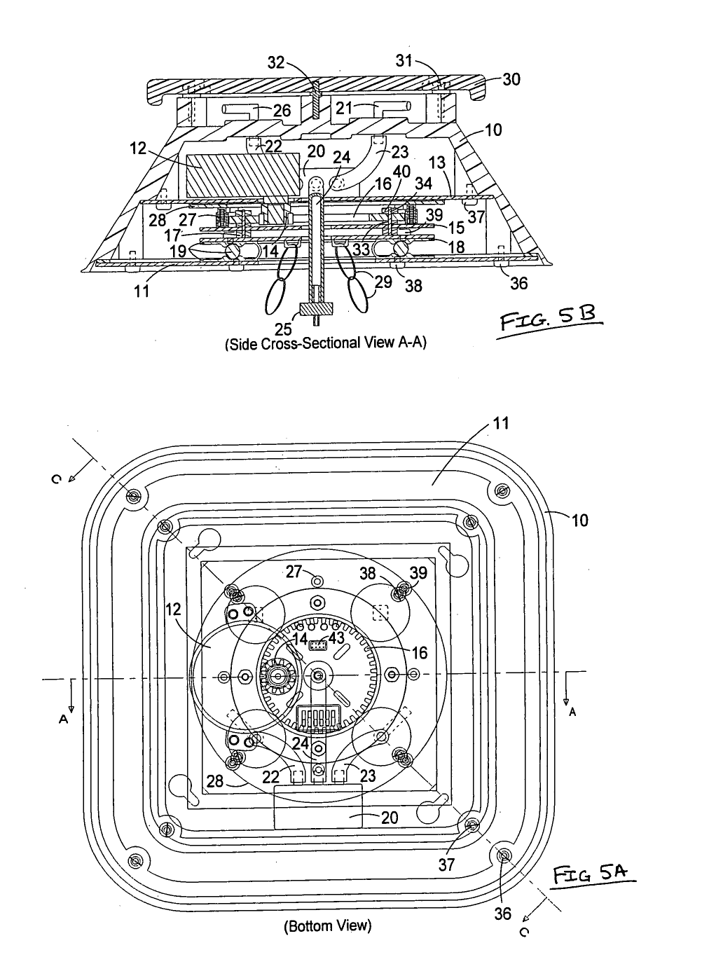

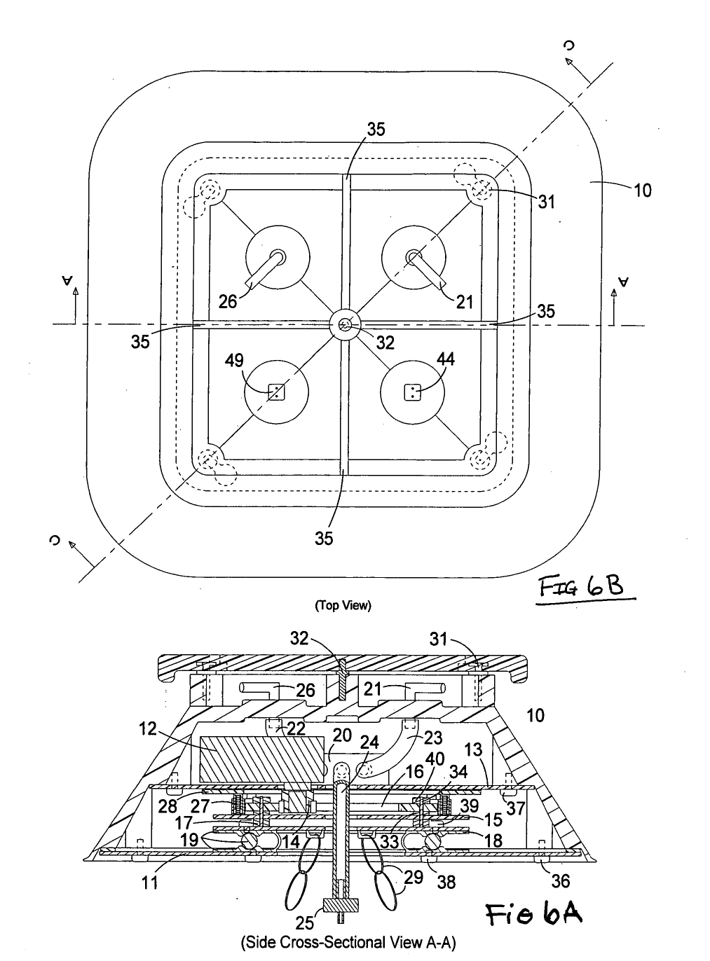

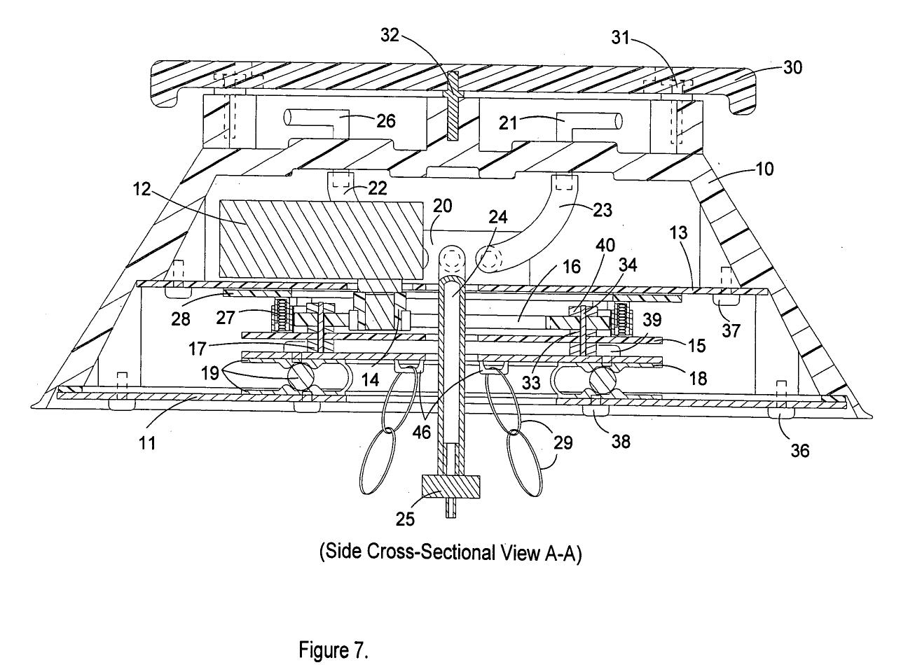

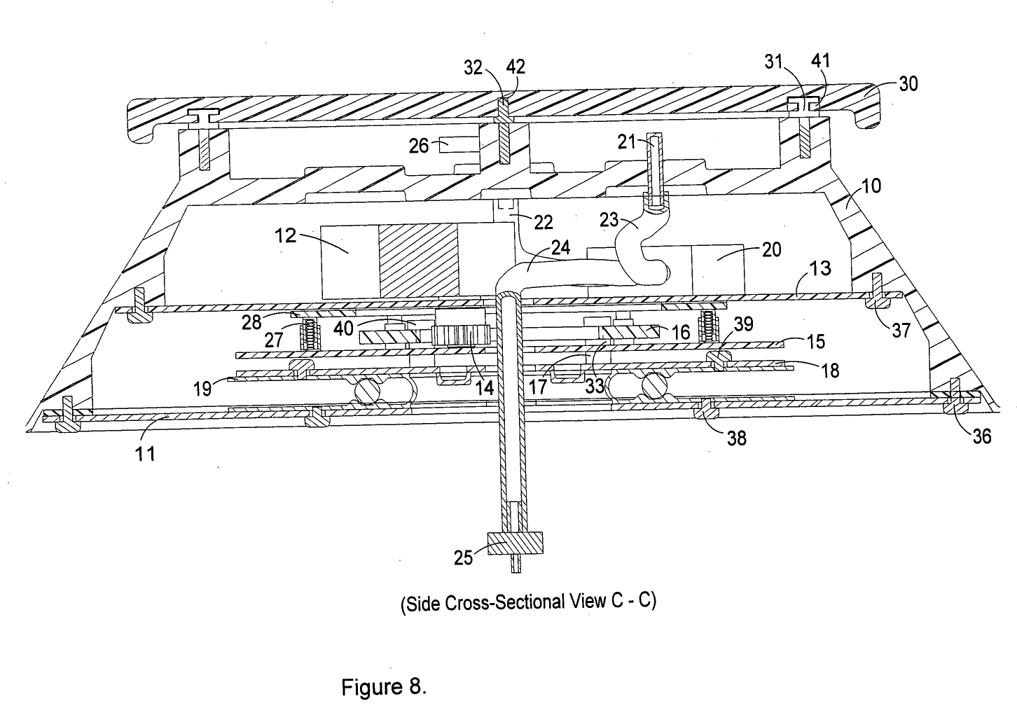

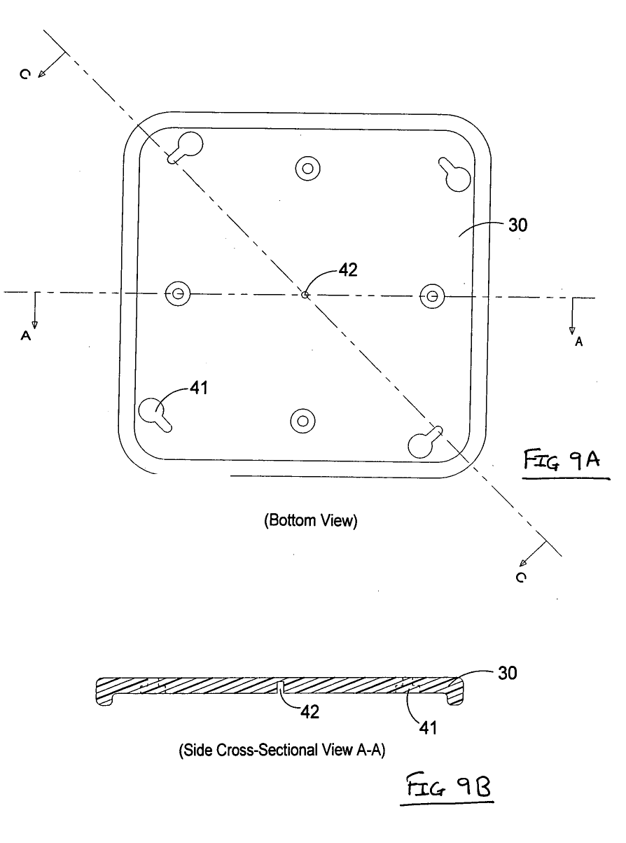

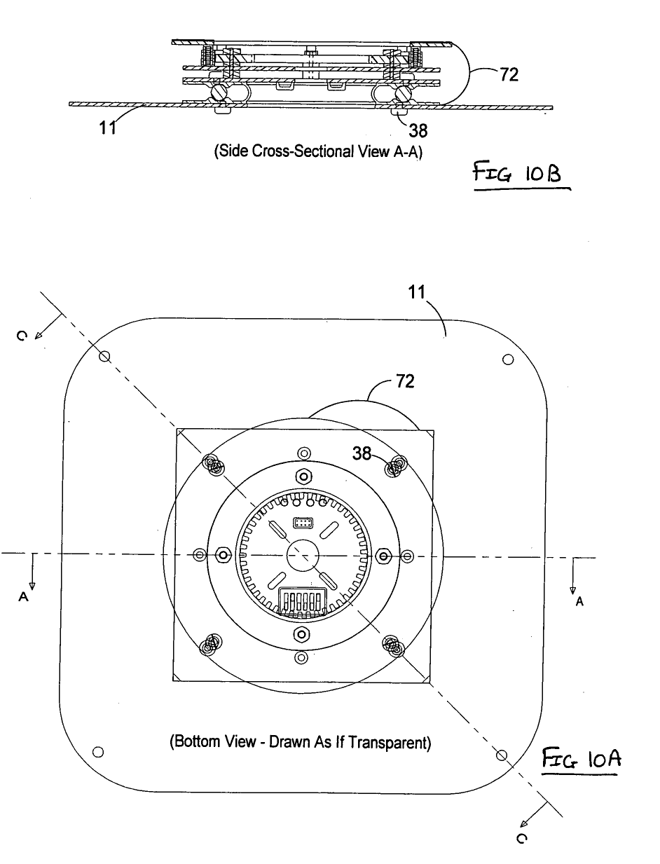

FIG. 3 gives a cut-away cross sectional side view of the physical construction of the Hanging Planter Apparatus (HPA) 1. The HPA includes an Overhead Module Assembly 2 (which contains the HPA's electronic circuitry and external connectors), a Soil Container Assembly 4 that hangs from the overhead module by chains or other types of ligaments 29. FIGS. 4, 5, 6, 7, and 8 depict the HPA overhead module's construction. FIGS. 4A-4C illustrate the Top, Side, and Bottom view of the HPA's overhead module 2. FIGS. 5A-5B give a bottom view of the overhead module 2 (drawn as if all of the components in the lower section were transparent) along with a side cross-sectional view. A top view of the overhead module is given in FIGS. 6A-6B. FIG. 7 and 8 give enlarged cut-away cross-sectional side views of the overhead module 2. The overhead module's overhead mounting plate 30 is illustrated in FIGS. 9A-9B.

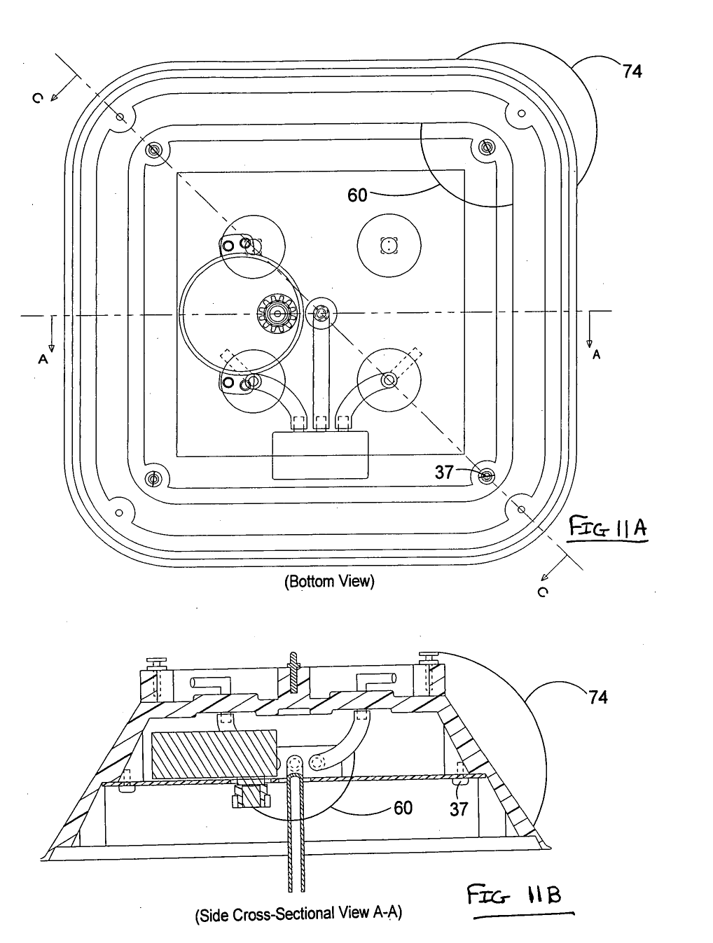

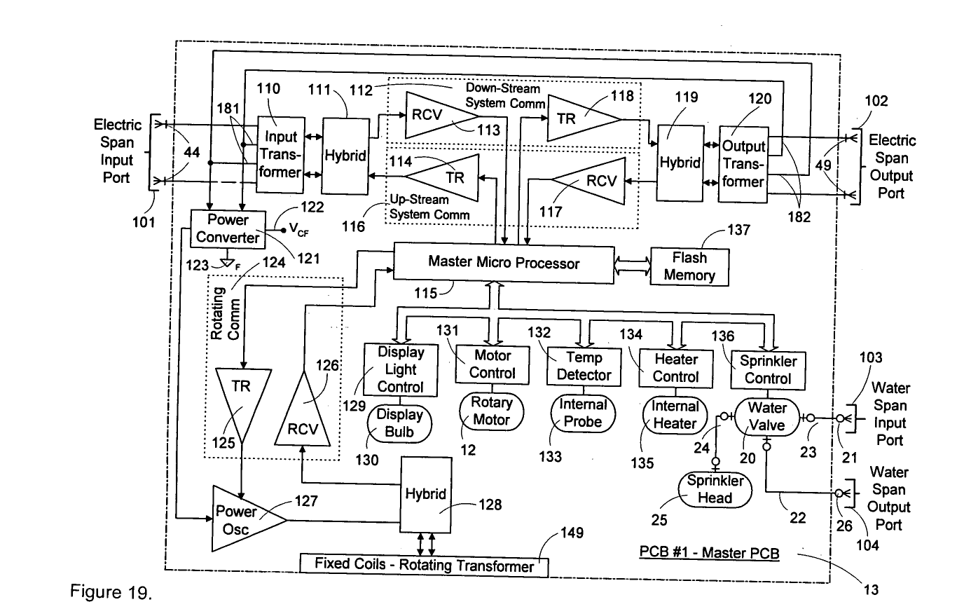

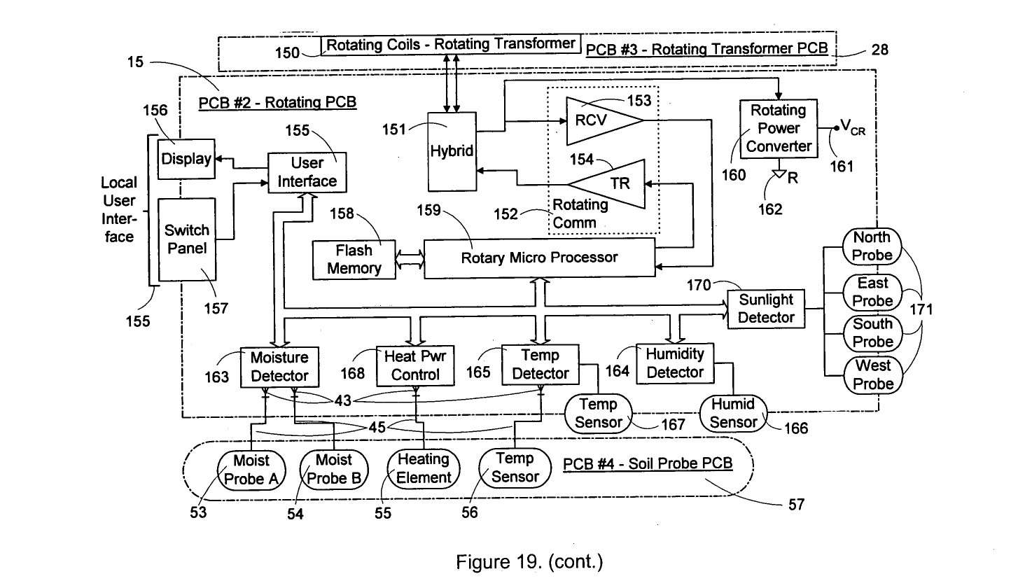

The assembly structure of the HPA's overhead module 2 is further illustrated in the individual sub-assembly drawings given in FIG. 10 through 17. The HPA's Soil Container Assembly 4 is shown in the top view and side cross-sectional view given in FIGS. 18A-18B. A functional block diagram of the electronic circuitry of the HPA 1 is given in FIG. 19.

Overhead Module Construction:

The housing 10 of the overhead module 2 is used to contain and protect the electronic circuitry of the apparatus and to provide all external connections to the HPA. The housing can be constructed using cost effective injection molding construction techniques. The housing has two sections; the upper section, which is accessible to the user when the overhead module is not connected to the overhead mounting plate 30, and the lower section, which contains the overhead module's electronics and is not accessible unless the mounting plate 11 is removed. The user does not need access to this lower section for normal installation or operation.

Housing Upper Section: The external connections for the electrical span line 44 & 49 and the water feed line 21 & 26 are given in the upper section of the housing and are accessible before the housing is snapped onto the overhead mounting plate 30. In this manner, the user can connect the electrical span line 207 and the water feed line 206 to the overhead module 2 during installation then snap it into the overhead mounting plate that is already attached to the overhead support structure 5.

The four narrow channels 35 in the upper section of the overhead module's housing 10, which point in the four cardinal directions, allow entry access for the electrical span and water feed lines into the upper section of the housing. These channels also provide water drainage for any water, which could possibly be trapped otherwise in the upper section. The base level of this section of the housing is shaped to ensure drainage through the four channels 35, and the mounting mechanism for the electrical and water span line connectors ensure a water seal to the inside of the lower section of the housing.

Housing Lower Section: The lower section of the HPA's overhead module's housing 10 is used to contain and protect the HPA's electronic circuitry, control mechanisms, and internal sensors. The base plate 11 of the lower section of the housing serves as both a cover for the lower section of the housing and as a support for a centrally located rotating mounting plate. This rotating mounting plate 18 provides a mounting mechanism 46 for the top of the hanging soil container's 50 support ligaments 29. This rotating mounting plate also provides an electrical connector 43 for the cable harness 45 of the Soil Probe Assembly 3. The soil probe is buried into the soil and rotates with the hanging container. A centrally located hole 47 in the rotating mounting plate provides access for the sprinkler's 25 water feed tubing 24 to pass through. In this manner, the rotating mounting plate can be rotated freely around the water tubing that is not rotating. As the mounting plate rotates the support chains, the hanging soil container, and the soil probe all rotate with it.

The rotating mounting plate 18 is supported to the housings base-plate 11 by an inexpensive small lazy-susan type-bearing device 19. This lazy-susan style bearing can support heavy loads in the radial direction, which easily supports the weight of the plants and soil even in large size hanging basket containers. Thus, the HPA can be used with a variety and sizes of soil containers and plants without worry of over loading it. The lazy-susan bearing supports the weight of the hanging container and minimizes the torque required of the motor to drive the rotation, allowing for smooth operation with an inexpensive motor.

The rotating mounting plate 18 is attached to the top plate of the lazy-susan bearing 19 using fasteners 39. The bottom plate of the bearing is attached to the housing's base plate 11 using fasteners 38. The large centrally located hole typically found in the lazy-susan style bearing is then used to gain outside access to the bottom of the rotating mounting plate where the mounting mechanism 46 for the support ligaments 29, the electrical connector 43 for the soil probe 3, the sprinkler's 25 water tubing 24, and the local user interface's 155 display 156 and switch panel 157 all exit the housing.

The rotating mounting plate 18 is rotated through the use of an electrical motor 12 and a simple gear drive. A small spur gear 14 is mounted to the shaft of the electrical motor. Likewise, an internal style gear 16 is centrally mounted to the topside of the rotating mounting plate 18. The motor is mounted to the housing in a fixed position such that when the motor shaft turns, the spur gear rotates the internal gear around the central axes of the housing. Again, the center hole in the internal gear and the offset position of the motor and spur gear allow access for the sprinkler's 25 water feed tubing 24 to pass through.

It should be noted that there are alternate gear drive systems that would also work for the apparatus. As an example the internal gear 16 could easily be replaced with an external gear that is similarly mounted to the rotating mounting plate. This external gear would commonly have an open central hole enabling the water tubing for the sprinkler to pass through. The position of the motor placement could easily be modified to drive an external gear rather than the internal gear.

The electronic circuitry mounted inside the HPA's overhead module housing 10 is built on one of two separate Printed Circuit Board (PCB) assemblies. The Master PCB 13 is mounted directly to the housing using fasteners 37 and is fixed in position. The second Rotating PCB 15 is mounted to the topside of the rotating mounting plate and rotates with it. The Rotating PCB 15 and internal gear 16 are both mounted to the topside of the rotating mounting plate 18 using the fastener studs 34 attached to rotating mounting plate, standoff fasteners 17 & 33, and fasteners 40.

The electronics mounted onto the Rotating PCB 15 include the circuitry required to interface to the Soil Probe Assembly 3, the circuitry required to communicate with the microprocessor on the Master PCB, and a power converter circuit to support the electronics on the Rotating PCB's and in the soil probe. Since the Soil Probe Assembly 3 is buried in the soil container and rotates with it, the electronics needed to power, read the soil probes' sensors, and drive the soil heating element all also need to rotate because of the wiring connecting the probe to the electronics. Thus, by having a rotational PCB mounted to the rotating mounting plate the wiring is not twisted with each revolution and the electronics rotates with the hanging container.

This Rotating PCB 15 contains the electronics needed to drive and read the soil temperature sensor in the soil probe, and to communicate the results back to the microprocessor on the Master PCB 13. Likewise, the Rotating PCB contains the electronics needed to read the soil moisture sensors in the soil probe and communicate the results back to the Master PCB 13. In addition, the electronics on the Rotating PCB must provide power for the heating element in the soil probe when requested by the master microprocessor.

In order to provide power from the Master PCB 13 to the Rotating PCB 15 and to enable the required 2-way communication channel between these two PCBs, an electrical transmission channel must be provided between them. There are several types of channels that can be used to accomplish this task and may be used in this invention. One type of channel would be to provide a conduction path between the fixed position PCB and the rotating PCB using several concentric slip rings commonly used to transfer electrical power between fixed and rotating objects. Another powering option for the Rotating PCB includes the use of an independent power source like a battery that can also rotate with it. There are many other techniques well documented to accomplish this task and are applicable for the present invention. The abundance of these techniques may be evaluated for the application in this invention and the advantages and disadvantages should be considered based on quality, reliability, maintenance requirements, and cost effectiveness.

For the automated hanging planter embodiment of the invention, the selected transmission channel used to transfer electrical power and 2-way communications between the fixed position PCB and the rotating PCB, is based on a radiated (wireless) path. This technique was chosen over a conducted path in order to enhance the reliability of the long-term operation of the apparatus and due to its low cost. The basic operation of this approach is based on the well-documented and commonly used principles of an electronic transformer. By placing two coil elements in close proximity of each it is possible to drive an electrical signal into one of the coils and induce a corresponding electrical signal into the adjacent coil; this is commonly called an electronic transformer. The electric and magnetic fields radiated from the driving coil that is excited with an electrical current, will induce a corresponding electrical current in the separate receiving coil. The coupling between these two separate coils is based on the turns ratio of the two coils and the coupling of the electric and magnetic field between the two coils.

A unique differentiation between the transformer concept in this invention and that of typical electrical transformers commonly used today, is that in the embodiment of the invention one of the coils is slowly rotating about a center axis between the two coils while the other coil is fixed in position. Experiments have shown that this rotation has negligible effects on the transformer properties if the rotation is around the center axis of both coils.

As seen in the FIGS. 5-8, the rotating transformer between the two PCBs involve a second rotating PCB 28 mounted to the initial rotating PCB 15 by means of spring mounted electrical stand-offs 27. The second rotating PCB 28 has concentric coils mounted to its topside. These coils are positioned to optimize coupling to corresponding coils placed on the bottom side of the Master PCB 13. The spring-mounted stand-offs 27 optimize the vertical separation between the coils. An oscillator on the fixed position PCB drives an AC current through the coils on the Master PCB 13. This signal induces an electrical voltage and current into the rotating coils on the Rotating Transformer PCB 28. A power converter on the Rotating PCB 15 then uses this induced AC signal as an input to generate the DC voltages required to power the electronics on the Rotating PCB and to power to the soil probe.

This rotating transformer is also used to provide a two-way communication channel between the fixed PCB and the Rotating PCB Assembly. For further explanation on this communication channel please refer below to the section entitled “Functional Block Diagram of the HPA Electronic Circuitry”.

A similar approach to passing power between the fixed and rotating PCBs is also possible using capacitive coupling techniques. The fixed coils 149 on the Master PCB 13 could be replaced with a donut shaped metallic plate. The rotating coils 150 on the Rotating Transformer PCB 28 would be similarly replaced with matching donut shaped metallic plates. If a thin insulating type material is placed between these fixed and rotating plates, a capacitor is formed. The resulting capacitor can now be used to pass a high frequency signal between the Master PCB 13 and the Rotating PCB Sub-Assembly 61. As the Rotating PCB Sub-Assembly is rotated about the center axis of the donut shaped plates, the capacitive coupling will not vary. With both the rotational transformer and the rotational capacitor approach, it is possible to pass power between the Master PCB and the Rotating PCB Sub-Assembly in a wireless manner since there are no metallic connections between them.

A water valve 20 is mounted on the Master PCB 13, which is used to add moisture and fertilizer to the plants in the soil container. The input to the water valve is connected to the water span supply line tubing 206 by means of the overhead module's water connection input port 21 and internal water tubing 23. This water valve 20 provides an “always-on” output port to the down stream span using internal water tubing 22 and the overhead module's water connection output port 26. This always on connection provides water to the down stream span line. The internal valve 20 also provides a “normally-closed” output port that is connected to the overhead module's sprinkler 25 by water tubing 24. The sprinkler head 25 and water tubing 24 drop through a centrally located hole in each of the rotating parts of the apparatus as mentioned above. This allows the sprinklers water feed line to maintain a fixed position through the center axis of the overhead module without being twisted or tangled by the rotational parts of the apparatus.

The benefit of the rotational capability in the apparatus can also be used to benefit the even distribution of water to the soil container. One type of sprinkler used commonly today to provide moisture to a planter is a drip type head. The drip head sprinkler simply provides a slow drip of water droplets to the container. There is a choice of drip rates available in these types of drip sprinklers with ½ gallon per hour, 1 gallon per hour, and 2 gallons per hour typically and easily found. Experience with the actual use of these drippers, reveals a downfall in the effectiveness of the dripper. When the dripper is held in a fixed position relative to the soil container, a micro tunnel is established in the soil container after the first few initial waterings, which allows the majority of the water dripping from the fixed position head to flow through the tunnel and out the bottom of the container before it can be absorbed into the surrounding soil. This tunnel effect worsens with each watering and ultimately causes a container that is using a fixed time water cycle to become under watered. This effect is also worse if the soil container is allowed to dry out between watering. If the soil in a container is allowed to become extremely dry, it is very difficult to get water reabsorbed evenly in the container using a fixed position drip style sprinkler head.

Since the present invention can rotate its container relative to the fixed position of its drip sprinkler head, it can reduce or eliminate the soil tunneling effect described above. If the drip sprinkler head is off-set from the center of the soil, the HPA can rotate the soil container during the watering cycle to distribute the drops randomly and evenly around the container. In this way, more of the water is absorbed in the soil. In addition, the HPA can use its water valve 20 to control the rate of water flow over time to maximize the absorption of the water to the soil and minimize the amount of water that is lost out of the bottom of the container during the watering cycle.

The overhead mounting plate 30 is used to mount the overhead module 2 to an overhead support structure 5. An example of an overhead support structure that is commonly used for hanging basket planters is the over hang of the roof for a household dwelling. The overhead mounting plate 30 is designed to be mounted securely to the overhead structure and to enable the overhead module to be easily attached and removed from it. The design of the overhead mounting plate enables it to be mounted to the overhead structure in a variety mounting configurations to adapt to the desired location for the automated planter. For example, the overhead plate can be screwed directly to the overhead structure, or by using an optional eyebolt it can be suspended from a hook. Similarly, using an extension plate, it can be mounted to cantilever out beyond the front edge of the roofs overhang possibly increasing the exposure of the planter to the sun.

The overhead module 2 easily attaches to the overhead mounting plate using the center head pin 32 and the shoulder head pins 31 on the overhead module. The center head pin 32 engages into the center alignment hole 42 in the overhead mounting plate. This center engagement pin 32 then allows easy alignment of the shoulder head pins 31 into the wide opening of the keyhole slots 41 in the overhead mounting plate. After the shoulder pins 31 are aligned into the keyhole slots 41 a small twist of the overhead module 2 around the center axis of the center alignment pin 32 snaps the shoulder head screws securely into the narrow end of the keyhole slots and securely attaches the overhead module to the mounting plate 30.

Overhead Module Assembly Structure:

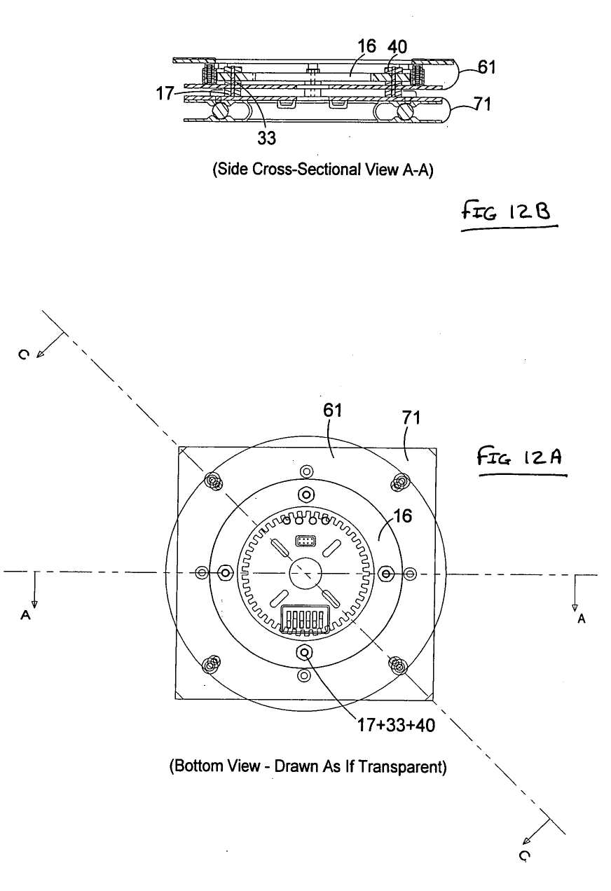

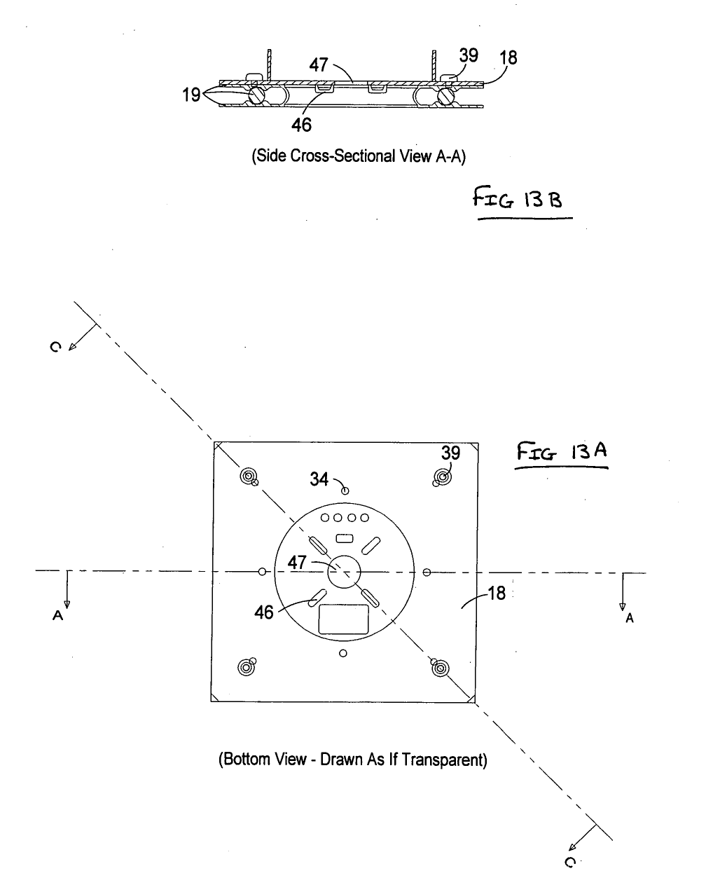

The assembly structure of the HPA's overhead module is illustrated in the FIGS. 10-17. The final assembly of the Overhead Module Assembly 2 is accomplished when the Base Plate Sub-Assembly 73 (illustrated in FIGS. 10A-10B) is mounted on the Housing Master Sub-Assembly 70 (illustrated in FIGS. 11A-11B) using fasteners 36. The alignment of the Motor 12 in the Housing Master Sub-Assembly 70 is positioned to engage its spur gear 14 with the internal gear 16 mounted on the Base Plate Sub Assembly 73.

Base Plate Sub-Assembly: The Base Plate Sub-Assembly 73 is illustrated in FIG. 10. This sub-assembly is composed of the housing's base plate 11 with the Rotating Module Sub-Assembly 72 mounted to it using fasteners 38. The centrally located hole in the base plate, enables outside access to the bottom of the rotating mounting plate 18 where the mounting mechanism 46 for the support chains 29, the electrical connector 43 for the soil probe 3, the sprinkler's water tubing 24, and the local user interface's 155 display 156 and switch panel 157 all exit the housing.

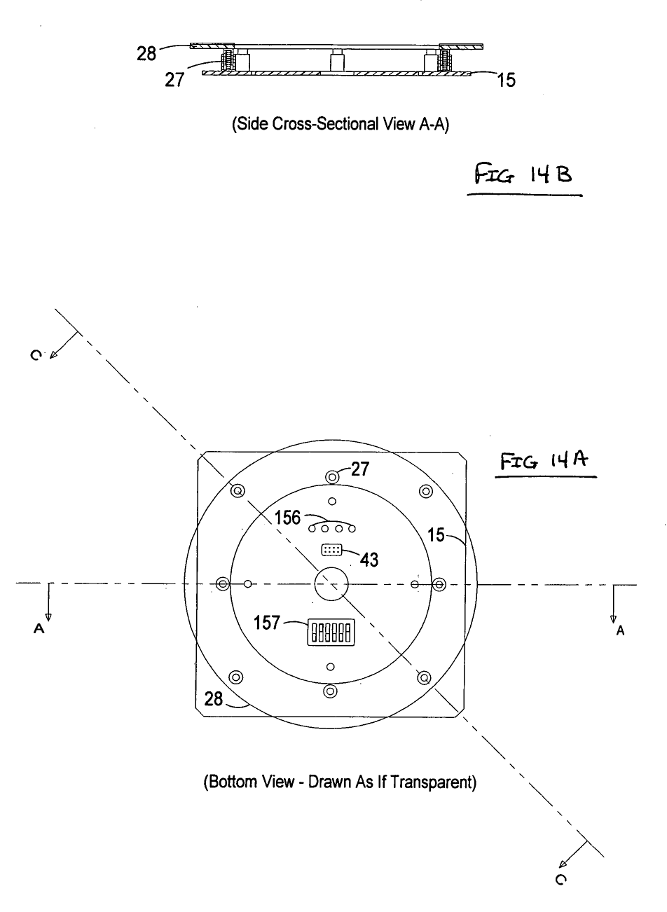

The Rotating Module Sub-Assembly 72 is illustrated in FIGS. 12A-12B. The Rotating Module Sub-Assembly includes the Rotating Bearing Sub-Assembly 71, the Rotating PCB Sub-Assembly 61, and the internal gear 16. These three components of the Rotating Module Sub-Assembly are held together using the fastener studs 34 on the rotating mounting plate 18, the plate-to-PCB standoff spacers 17, the PCB-to-gear standoff spacers 33, and the locking fasteners 40. The internal gear is mounted over the topside of the Rotating PCB 15, which is mounted above the topside of the rotating mounting plate 18.

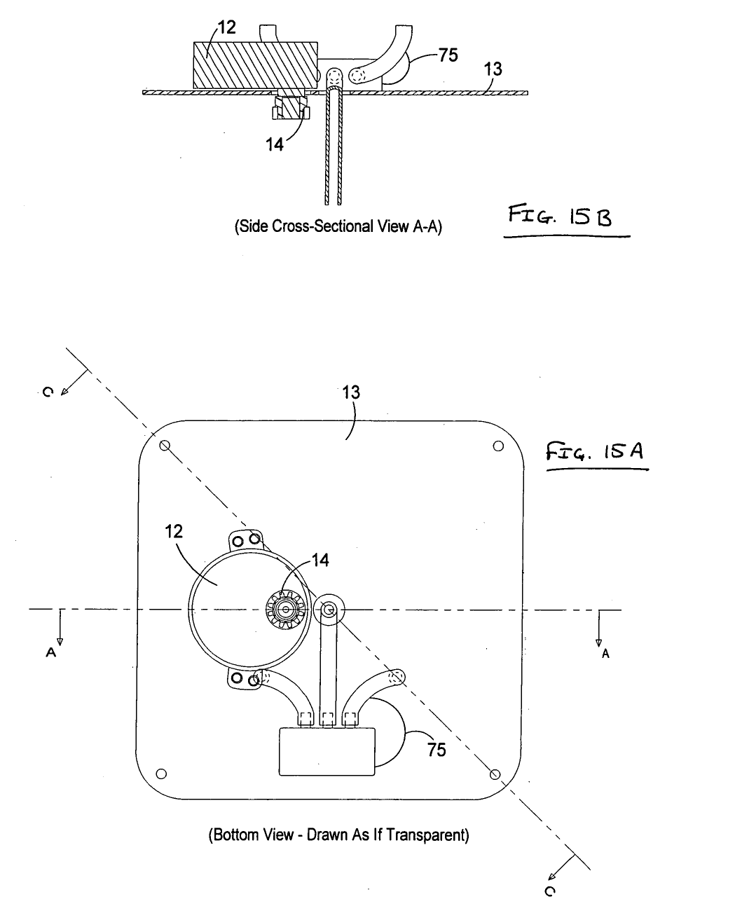

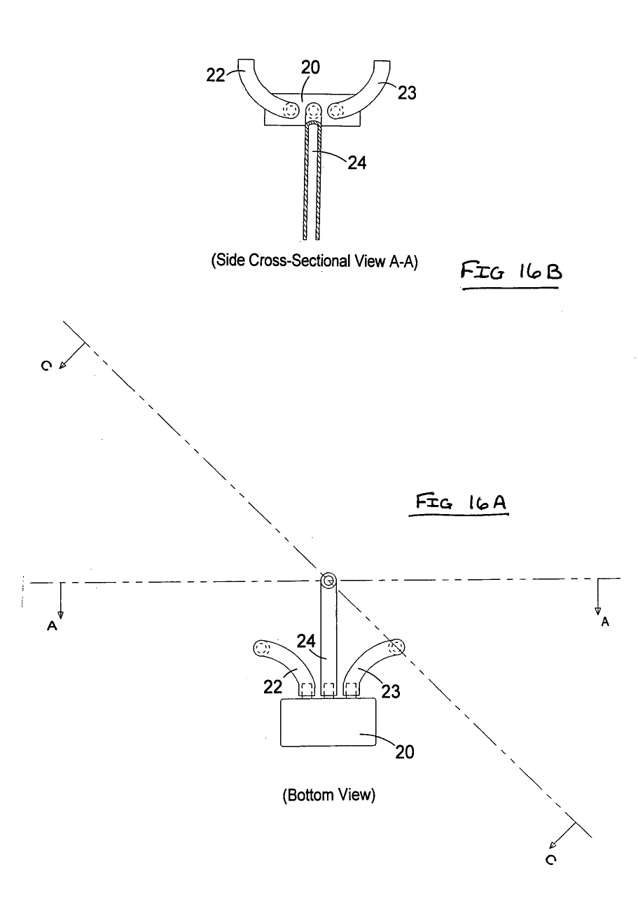

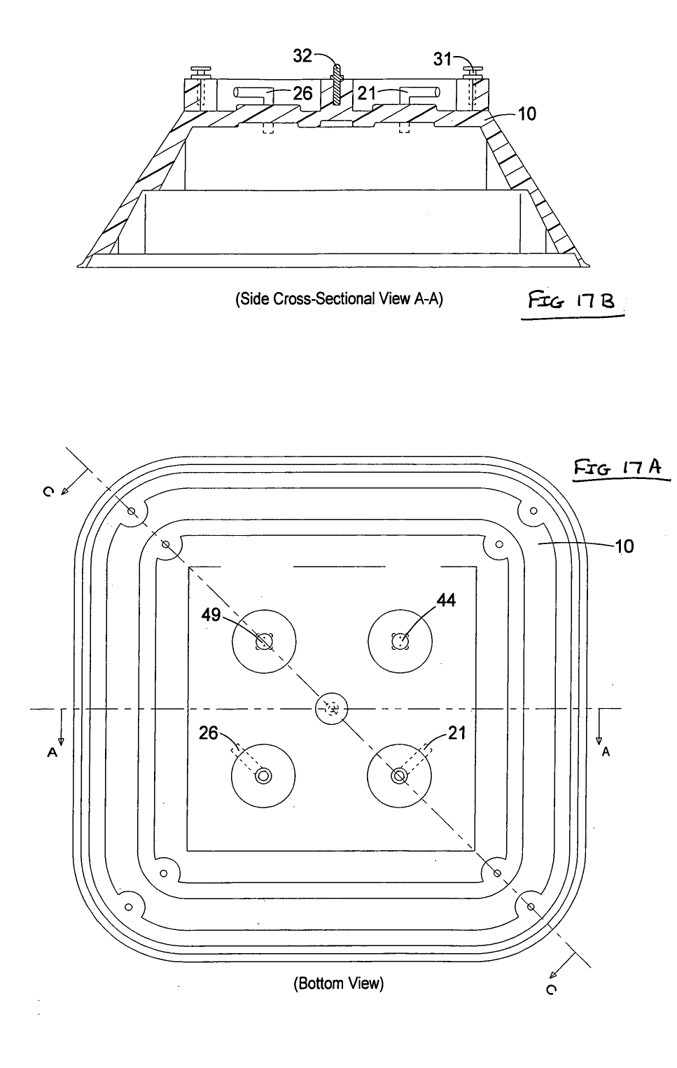

The Rotating Bearing Sub-Assembly 71 is illustrated in FIGS. 13A-13B. The lazy-Susan bearing 19 is mounted to the bottom of the rotating mounting plate 18 using fasteners 39. The Rotating PCB Sub-Assembly 61 is illustrated in FIGS. 14A-14B. In this sub-assembly the Rotary Transformer PCB 28 is mounted to the top surface of the Rotating PCB 15 using spring type standoffs 27.

Housing Master Sub-Assembly: The Housing Master Sub-Assembly 70 is illustrated in FIGS. 11A-11B. This sub-assembly is composed of the Mater PCB Sub-Assembly 60 mounted into the Housing Sub-Assembly 74 using screw fasteners 37. All of the components of this sub-assembly are fixed in position and do not rotate with the Rotating Module Sub-Assembly 72, except spur gear 14 and shaft of motor 12. As the Master PCB Sub-Assembly 60 is mounted to the Housing Sub-Assembly 74 the water system's tubing 22 & 23 must be inserted onto the input and output water span connectors 21 & 26 and the wiring harness from the electrical span connector 44 & 49 must be attached to the Master PCB 13.

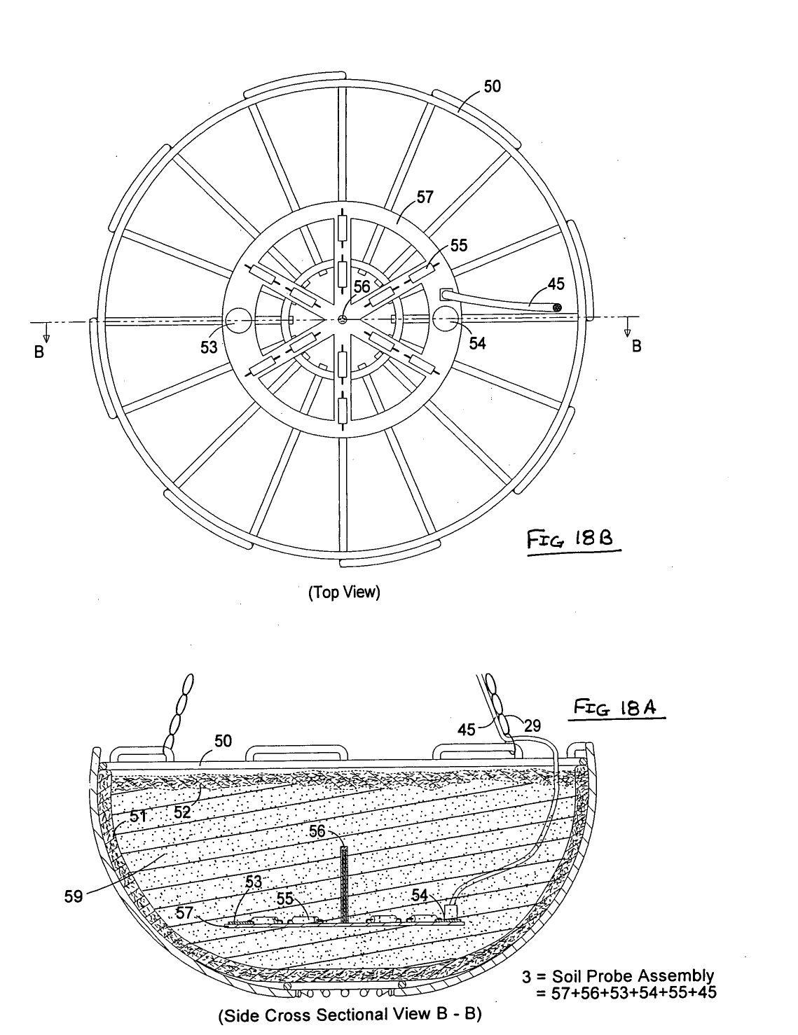

The Master PCB Sub-Assembly 60, illustrated in FIGS. 15A-15B, contains the central (master) electronics of the HPA providing the intelligence to the HPA, which allow it to read the sensors, interpret the results for the sensors and operate its control devices accordingly. The motor 12 required to turn the rotating module is mounted to the Master PCB 13. Likewise the water system 75, used to provide moisture and fertilization to the planter, is also located on the Master PCB 13. The water system is illustrated in FIGS. 16A-16B and includes the water valve 20 and the internal water tubing 22, 23, & 24.

The Housing Sub-Assembly 74 is illustrated in FIGS. 17A-17B. The Housing Sub-Assembly includes the following: the Over Head Modules' 2 weather resistant housing 10, the input and output water-tubing connectors 21 & 26 for the water feed line, the input and output connectors 44 & 49 for the electrical span line, and the center alignment pin 32 plus the shoulder-head pins 31 for use with the over head mounting plate 30. The connectors for the water and electrical span lines provide a watertight seal from the external upper section of the housing to the inside of the lower section of the housing.

Soil Container Assembly and Construction:

The Soil Container Assembly 4 is illustrated in FIGS. 18A-18B with a Top View and Side Cross-Sectional View. The Soil Container Assembly includes the soil container 50 & 51, the support ligaments 29, the soil probe 3, the soil 59, and the mulch layer 52. The soil probe 3 is built on the Soil Probe PCB 57 and includes the soil temperature probe 56, the soil moisture probes 53 & 54, the soil heating element 55, and the soil probe cable harness 45.

Since the Soil Container Assembly's support ligaments 29 are attached to the overhead module rotating mounting plates' support ligament-mounting links 46, and since the Soil Container Assembly's soil probe cable harness 45 is attached to the overhead module rotating mounting plate's soil probe electrical connector 43, the complete Soil Container Assembly rotates as the overhead module's rotating mounting plate 18 is rotated. The HPA ability to rotate its Soil Container Assembly enables the HPA to promote symmetrical growth and to efficiently provide moisture evenly over the soil container area.

Soil Container: The soil container 50 shown in FIGS. 18A-18B is of the open wire basket variety that requires a liner 51; typically coconut shell or sphagnum moss is used for the liner. An open basket with a coconut type liner promotes air exchange for healthy roots. These types of baskets are commonly used today. However, the HPA can use virtually any type of soil container that can be hung from chains or other type of support ligaments 29 to the HPA's overhead module. For example, the plastic and clay containers also commonly used today for hanging baskets are also well suited for this invention.

In order to reduce evaporation from the surface of the soil and to provide a thermal insulator during cool weather heating cycles, the top surface of the soil 59 is covered with a layer of mulch 52. There are several different materials that are commonly used and available for this mulch layer. Examples of common mulch types include sphagnum moss, pine straw, tree bark, etc.

Soil Probe: The Soil Probe Assembly 3 is buried into the soil 59 in the container 50 under the plants to be grown in the planter. The soil probe is attached to the overhead module using its cable harness 29 which mates with the overhead modules' soil probe electrical connector 43 mounted on the rotating mounting plate 18. The cable harness 45 can be routed up to the overhead module 2 adjacent to one of the support ligaments 29 to reduce its visibility.

The soil probe is constructed on the Soil Probe PCB 57; the HPA's soil probes 53, 54, & 56 and heating element 55 are all soldered to this PCB. In order to protect the soil probe, it is dipped into a conformal coating bath. After the conformal coating is cured it resists water and the chemicals in the soil protecting the soil probe components.

The soil probe is buried in the soil at a depth of approximately 2/3 of the total soil depth. This depth places the soil moisture probes 53 & 54 in the active root zone of the planter and enables measurement of the actual soil moisture content in this critical root zone area. The soil probes conformal coating is removed from the top metallic surface of these two probes 53 & 54 after curing. Since the electrical conductivity of soil is heavily dependent on its moisture content, the electronics in the overhead module connected to the soil moisture probes can use ac impedance measurement techniques to inexpensively measure the relative moisture content of the soil. Similarly, since the electrical conductivity of the soil is further dependent on its fertilization content, the electronics in the overhead module connected to the soil moisture probes can use AC impedance measurement techniques to also measure the relative fertilization content of the soil.

The depth of the soil probe also enables it to efficiently provide heat to the soil when needed. Since heat rises, the heating elements 55 on the Soil Probe PCB 57 are positioned to provide an optimal thermal profile across the area of the soil. Since the soil temperature probe 56 is mounted a few inches above the heating elements it gives feedback to the overhead module on the central temperature of the soil container. The mulch layer 52 covering the top surface of the soil and the outer liner 51 and soil container 50 holding the soil help to provide a thermal insulation barrier between the cold air temperatures and the warmer soil temperatures.

Functional Block Diagram of the HPA

FIG. 19 shows a functional block diagram of electric circuitry for the planter apparatus in accordance with exemplary embodiments of the present invention. The PCB modules in the apparatus contain this circuitry. The functional blocks in the illustration of FIG. 19 are separated by their physical placement in the apparatus using the PCB outlining blocks behind the functional blocks. The PCB modules are the Master PCB 13, the Rotating PCB 15, the Rotating Transformer PCB 28, and the Soil Probe PCB 57.

Master PCB Electronic Circuitry:

The Master PCB 13 is coupled with the overhead module's housing 10. This PCB module contains the master microprocessor 115 for the apparatus and is responsible for analyzing the apparatus sensor inputs and to operate the control devices appropriately to optimize the growing conditions for the plant in its container. This master microprocessor communicates on the System Communication Channel 112 & 116 with the other planter apparatuses 1 connected to the span and with the Span's Controller Unit 200. This communication channel enables the apparatus to share common resources like the span's electrical power, the span's water supply, and the span's fertilizer supply. The communication channel also enables advanced trouble shooting techniques to detect system or apparatus problems and/or faults, and to help predict imminent failures in the system that can be corrected prior to an actual failure that could be detrimental to the plants health.

The Master PCB 13 receives the electrical power for the apparatus from the electrical span line 207. The DC voltage imposed between the two wires of the span's electrical wiring 207 is fed to the power converter circuitry 121 through the apparatuses span line input port's 101 input transformer 110. This transformer is used to isolate the AC voltages on the span line induced by the bi-directional System Communication Channel 112 & 116 signals from the power feed DC voltage on the span. The input transformer 110 has a split center tap 181 on its primary coil facing the span line input port. The input to the power converter circuitry 121 on the Master PCB is tied to split center tap 181 on this transformer. The split center taps 181 of the input transformer 110 are also tied to the split center taps 182 of the output transformer 120. This extends the span's DC power feed to the span line wiring connected to the apparatuses output port. The DC power signal is thus connected in parallel through each apparatus and all of the apparatuses on the span are powered in a parallel manner.

The power converter circuitry 121 is used to convert the DC power feed voltage from the span to the various power supply voltages 122 required to power all of the electronics on the Master PCB 13. The power converter circuitry uses the well-documented high efficiency switch mode design techniques to perform its DC-to-DC converter function. This minimizes the power lost in the converter and helps to minimize the overall power demands on the span line. The output of the power converter will include several different rails (e.g. +5 VDC, +12 VDC, −12 VDC, etc.) to meet the requirements of the electronics on the Master PCB. All of the outputs of the converter will be relative to the Master PCB's ground potential 123, which is established by the power converter.

In addition to all of the other electronics on the Master PCB, the power converter 121 provides power to the Power Oscillator 127. The output of the power oscillator is an AC signal that is fed into the fixed position coils 149 of the rotating transformer connected between the Master PCB Assembly 60 and the Rotating PCB Assembly 61. This AC signal induces a corresponding signal into the rotating coils 150 of the rotating transformer. The signal induced in the rotating coils is used to generate power for the Rotating PCB electronics by its power converter 160. In this manner, the Master PCB's power converter 121 also converts power from the span line's DC power feed to the power required to for the electronics on the Rotating PCB and ultimately for the soil probe electronics.

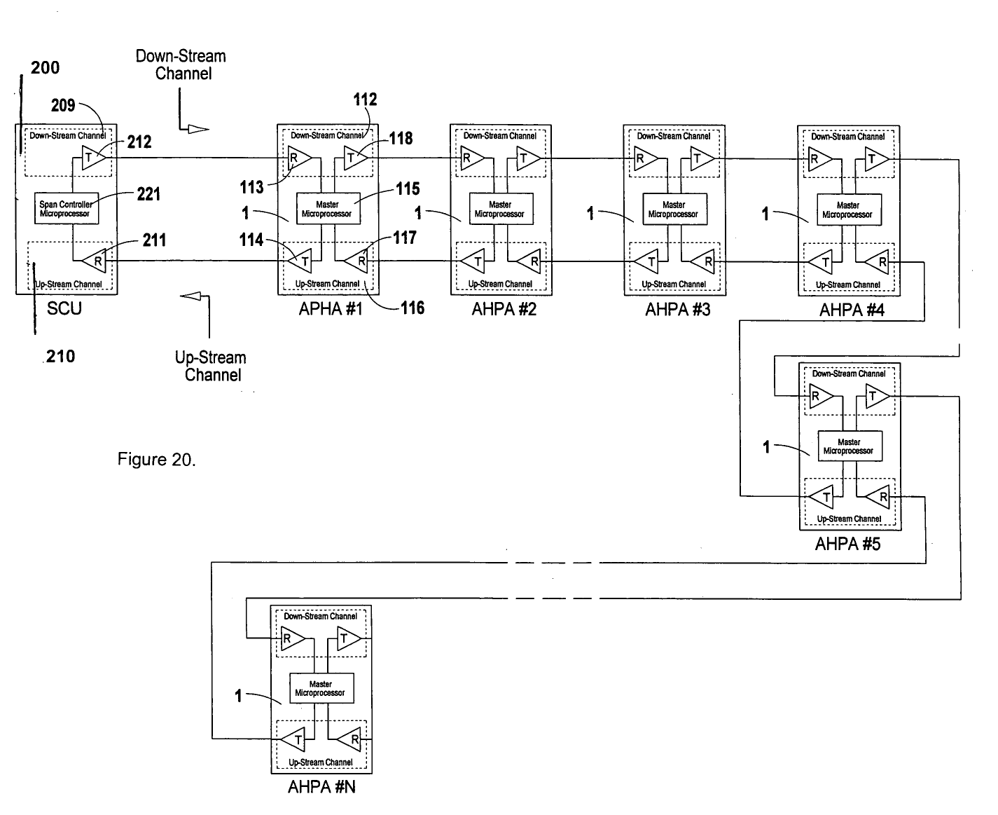

As seen in FIG. 19, the System Communication Channel has an up-stream channel 116 and a down-stream channel 112. The transmission path for the System Communication Channel is the 2-wire span line also used as the transmission path for the DC power feed. The apparatuses are connected together in a series fashion for the transmission path of the System Communication Channel. FIG. 20 illustrates the schematic diagram for the HPA system described in FIG. 2. HPA #2's down-stream channel receiver 113 communicates with HPA #1's down-stream channel transmitter 118, and HPA #2's down-stream transmitter 118 communicates with HPA #3's down stream receiver 113. Likewise, HPA #2's up-stream channel transmitter 114 and receiver 117 communicate directly with HPA #1's up-stream receiver 117 and HPA #3's up-stream transmitter 114, respectively.

With the series transmission configuration of the System Communication Channel commands are relayed through each apparatus so that all HPAs 1 on the span line can communicate with the Span Control Unit 200 and with each other. As an example, referring to FIG. 20, suppose HPA #3 wants to water the plant in its soil container. It would send a request to the SCU for permission to turn-on its sprinkler. It would send this request in the up-stream direction by sending a signal out its up-stream transmitter 114. This signal would be received by HPA #2's up-stream receiver 117. The master microprocessor 115 in HPA #2 would see that this request is for the SCU and would relay the request out its up-stream transmitter 114 to HPA #1's up-stream receiver 117. Likewise APPA #1 would relay the request out of its up-stream transmitter 114 to the up stream receiver 211 in the SCU.

The SCU would receive the watering request originated by HPA #3 and would send a reply back to HPA #3 over the down-stream channel either approving the request to water or placing a temporary hold on the request. The response from the SCU would be based on the present condition of the span including span power restriction, span water flow limitations, etc. Again, the response would be relayed from the SCU to HPA #1 to HPA #2 to HPA #3.

A benefit of the series connection for the transmission path of the System Communication Channel is that it enables automatic detection of the number of HPA units on the span and enables automatic detection of the position of each HPA units on the span. Firmware running in the master microprocessors in each HPA and in the SCU's microprocessor can use exiting techniques commonly used today in telecommunication spans to easily determine its position in the span and the total number of units on the span. This feature makes it easy to add additional HPA's to the system span or to move HPA in their relative position in the span. The user simply connects the 2-wire span to the input and output terminals, and the system will automatically recognize the additions or moves without concern or additional action by the user.

As illustrated in FIG. 19, the system communication channel uses bi-directional communication over the 2-wire span connected to its input and output ports through the use of hybrids 111 & 119 to isolate the up-stream and down-stream signals. The use of hybrids to support bi-directional communication on a 2-wire transmission panel is common in the field of telecommunications. The hybrid 111 tied to the input transformer's 110 secondary is used to isolate the down-stream receive signal from the up-stream transmit signal. The hybrid 119 tied to the output transformer's 120 secondary is used to isolate the down-stream transmit signal from the up-stream receive signal.

The master microprocessor 115 is responsible for the overall control of the HPA. The master microprocessor communicates with the SCU and the other HPAs on the span, it communicates with the rotary microprocessor 159, it monitors the results of all of the HPA's sensors, and it determines the operation of all of its control devices. The master microprocessor is connected to flash memory 137. The firmware executed in the master-microprocessor is stored in the flash memory and executed from it. The flash memory is also used by the microprocessor various storage requirements like the results from the sensors, historical data, operation mode, hold request, etc. The firmware stored in the flash memory can be upgraded in the field to add additional operating features or to change the current operational characteristics of the HPA.

The master microprocessor 115 communicates with the rotary microprocessor 159 over the rotating communication channel 124. The rotating communication channel is used to enable the master microprocessor to monitor the results of the sensors on the Rotating PCB 15 and on the Soil Probe PCB 57. The rotary microprocessor monitors these sensors and forwards the results to the master microprocessor. Similarly, the rotating communication channel is used to enable the master microprocessor to tell the rotary microprocessor to turn on or off the heating element in the soil probe 3.

The rotating communication channel uses the rotating transformer 149 & 150 as a bi-directional the transmission path. Again, a hybrid circuit 128 is used to isolate the bi-directional signal in the rotating transformer for the transmit circuitry 125 and receive circuitry 126.

The master microprocessor monitors internal air temperature in the overhead module 2 using temperature detector circuitry 132 and internal temperature probe 133. It monitors this temperature in order to protect the water valve 20 and water tubing 22 & 23 from damage that could be caused if the water in the valve and tubing were to freeze. If severe cold conditions are detected the master microprocessor can use the internal heater control circuitry 134 and internal heating element 135, to protect the HPA's internal components from freezing.

The master microprocessor controls the rotating mechanism of the HPA through the motor control circuit module 131 to turn the rotary motor 12 on/off. Similarly, the master microprocessor can turn on the HPA's display lighting 130 using the display light control circuitry 129.

The master microprocessor controls the water sprinkler for the HPA using the sprinkler control module 136 to turn the water valve 20 connecting the sprinkler head 25 to the span's water supply line 207.

The fixed coils 149 of the rotating transformer are mounted to the Master PCB 13. These coils are fixed in position and are tied to the power oscillator 127. The power oscillator drives an ac signal through these fixed coils 149. The current of the ac signal in the fixed coils generates and electromagnetic field that is coupled into the rotating coils 150 on the Rotating Transformer PCB 28. The ac signal from the power oscillator is used to provide power to the power converter on the Rotating PCB 15. The transmit circuitry 125 for the rotating communication channel 124 on the Master PCB 13 can modulate the output of the power oscillator to enable communication from the mater microprocessor 115 over the rotating communication channel to the rotary microprocessor 159.

Rotating Transformer PCB Electronic Circuitry:

The only circuitry located on the Rotating Transformer PCB 28 is the rotating coils 150 of the rotating transformer. The input and output leads of the rotating coils are tied to the Rotating PCB 15 through the spring mount electrical stand-offs 27 connecting the Rotating Transformer PCB 28 to the Rotating PCB 15. These spring mount stand-offs are used to ensure a uniform and optimum spacing between the rotating coils 150 and the fixed coils 149 of the rotating transformer.

Rotating PCB Electronic Circuitry:

The Rotating PCB 15 is mounted directly to the rotating mounting plate 18 and is a component of the Rotating Module Sub-Assembly 72. As such all of the electronic components mounted on the Rotating PCB and all wiring tied directly to it, rotate when the HPA is in its rotational mode. This PCB contains the rotary microprocessor 159 and the electronics needed to monitor and power the sensors and heating element on the Soil Probe PCB 57, and to monitor the other rotational sensors. This rotary microprocessor communicates on the Rotating Communications Channel 152 with the master microprocessor 115. This communication channel enables the master microprocessor to monitor all of the rotating sensors and control the heating element in the soil probe.

The Rotating PCB 15 receives the electrical power from the rotating transformer coils 150. The AC voltage and current induced in the rotating coils from the fixed transformer coils 149 is fed to the rotating power converter's 160 input. The rotating power converter circuitry 160 is used to convert the AC input power to the various power supply voltages 161 required to power all of the electronics on the Rotating PCB 15 and on the Soil Probe PCB 57. The power converter circuitry uses the well-documented high efficiency switch mode design techniques to perform its AC-to-DC converter function. This minimizes the power lost in the converter and helps to minimize the overall power demands. The output of the power converter may include several different rails (e.g. +5 VDC, +12 VDC, −12 VDC, etc.) to meet the requirements of the electronics on the Rotating PCB and Soil Probe PCB. All of the outputs of the converter will be relative to the Rotating PCB's ground potential 162, which is established by the power converter.

The Rotating Communication Channel 152 uses the rotating transformer 149 & 150 as a bi-directional the transmission path. Again, a hybrid circuit 151 is used on to isolate the bi-directional signal in the rotating transformer for the transmit circuitry 154 and receive circuitry 153.

The rotary microprocessor 159 is responsible for monitoring all of the rotating sensors, for controlling power to the soil-heating element, and to report the results of the monitored sensors to the master microprocessor 115. The rotary microprocessor is connected to rotary flash memory 158. The firmware executed in the rotary microprocessor is stored in the flash memory and executed from it. The flash memory is also used by the microprocessor various storage requirements. The firmware stored in the flash memory can be upgraded in the field to add additional operating features or to change the current operational characteristics of the HPA. The master microprocessor would receive the firmware upgrade over the span and forward it to the rotary microprocessor through the Rotating Communications Channel.

The rotary microprocessor monitors external air temperature and the apparatuses' soil temperature using the temperature detector circuitry 165, the air temperature probe 167, and the soil temperature probe 56. The humidity detector circuitry 164 and humidity sensor 166 are used by the rotary microprocessor to monitor the air humidity of the apparatuses operating environment. It monitors the air temperature and humidity of the apparatuses' environment so the master microprocessor can track the present and historical environmental conditions. This input is used by the master microprocessor to help determine the moisture requirements of its planter. The soil temperature is also monitored by the master microprocessor not only to be used as an input to the watering requirements, but the soil temperature is also used to control the soil heating element.

The rotary microprocessor uses the moisture detector circuit 163 and moisture probes A and B 53 & 54 on the Soil Probe PCB to track the moisture content of the planters soil. The moisture detector circuit uses commonly known principles to measure the electrical resistance of the moisture probes. The probes are buried in the soil and the amount of moisture in the soil directly affects the electrical resistance of the probe. The electrical resistance of the probe increases as the soil moisture content decreases. So by measuring the electrical resistance of the soil probes, the rotary microprocessor can track the soil moisture contact, the effectiveness of watering cycles, and the rate of moisture evaporation from the soil.

The sunlight detector circuit module 170 and the four cardinally oriented UV probes 171 are used by the rotary microprocessor to monitor the UV radiation environment of the apparatus. Orienting four probes in the four cardinal directions lets the apparatus determine UV illumination uniformity in direction, determine day from night, determine length of the current daytime cycle and night time cycle, and to determine the speed and direction of the rotation of the apparatus during its rotational mode.

The heater power control circuit 168 and the soil-heating element 55 on the Soil Probe PCB 57 are used by the rotary microprocessor to add heat to the soil in the apparatus soil container 50 during periods of cold weather. Heating the soil enables the apparatus the ability to minimize short periods of freezing temperatures or to extend the growing season for certain types of plants.

The user interface module 155 on the Rotating PCB 15 enables the rotary microprocessor to read the user selectable switch panel 157 and to illuminate the LED display 156 to provide visual indications to the user about operating and/or fault modes of the apparatus. The switch panel 155 is used to program the apparatus with desired operating modes and to give the apparatus an indication of the type of plants used in the planter. This interface is used to setup generic plant types and operational modes when they are used individually or on small systems that do not have an SCU monitoring the system or when a personal computer is not accessible to the system. The LED display enables the user who is local to the apparatus to see its present operating mode and determine if there are any detected problems.

Soil Probe PCB Electronic Circuitry:

The Soil Probe PCB 57 is buried into the soil in the soil container 50. The Soil Probe PCB 57 is a component of the Soil Probe Assembly 3 in the Soil Container Assembly 4. This PCB contains the following components: the soil temperature probe 56, the soil moisture probes A and B 53 & 54, and the soil heating elements 55. The soil probe cable harness 45 is attached to this PCB at one end and has a mating connector for the “overhead modules' soil probe” connector 43 at the other end.

The soil moisture probes A and B 53 & 54 are simply metallic contacts that are shaped and positioned to make consistent contact to the soil. The AC conductance of the soil is heavily dependent on its moisture content. The moisture detector circuitry measures the AC impedance of the soil between moisture probe A 53 and moisture probe B 54. The value of the AC impedance measured gives an indication of the relative moisture content of the soil. The precise calibration between the measured AC impedance and the absolute moisture content percentage is dependent on several factors in addition to the moisture content. The measured AC impedance is also dependent on other soil contents including both its physical particle make-up as well as other chemicals present in the soil including fertilizers. However, for the purpose of the functionality of the APA of this invention it is not a requirement to have a precise calibration of the absolute moisture content percentage. By tracking the historical relative moisture content measured and by using its moisture control valve, the HPA can determine an estimated soil moisture content with an accuracy that is better than required for the APA functionality.

Since the electrical conductance of the soil is dependent on the fertilization content of the soil, the moisture detector circuitry can be used to additionally estimate the fertilization content of the soil. By tracking historical values for measured moisture readings after a watering cycle, the HPA controller can track the relative fertilization content of the soil. By tracking the relative fertilization content after each water cycle and by knowing the plant's fertilization preferences, the Planter Apparatus can provide a fertilization schedule based on actual soil readings and on plant preferences. HPA units that are installed on a system with an SCU can add fertilization automatically by requesting fertilization to be added to the container's water cycle. If the HPA is installed on a small system without an SCU or Span fertilization resources, it will illuminate an indicator on the Local User Interface Display 156 to indicate to the user that fertilization should be added manually.

The soil temperature probe 56 is mounted in an elevated position above the Soil Probe PCB 57. This position places the probe in an approximate central location inside the soil container. The type of probe used is primarily a function of cost effectiveness and there are several types of temperature probes commonly used in similar application. Examples of thermal probe types include Negative Temperature Coefficient Thermistors (NTC), Resistance Temperature Detectors (RTD), etc. These thermal probes are readily available and typically provide an electrical resistance that is dependent on the absolute temperature of the probe. By placing the soil probe inside the conformal coating on the soil probe, it is protected from the corrosive properties of the soil. The HPA's temperature detector electronic module can the measure the resistance of the thermal probe to provide an indication of the containers soil temperature to the HPA's microprocessor. The microprocessor can be programmed with the calibration curve of the soil probe detector used to determine the actual soil temperature based on the resistance measured.

The heating elements 55 on the Soil Probe PCB are used to convert electrical energy to heat energy. The amount of heat energy required in the HPA is dependent on several factors including; the soil planter size, the thermal insulating properties of the soil container and mulch layer, the desired soil temperature range, and the intended outside air temperature range. Experiments on prototype HPA has found that for typical hanging container sizes that an 8 to 12 watts heat element works for typical applications. The heating elements used can be simple resistance elements soldered onto the PCB as shown in the Figs. The individual elements should be spread evenly across the PCB to distribute the heat evenly throughout the soil. Alternatively, the heating element could be etched directly onto the PCB as with Thermofoil™ Heaters commonly available.

Planter Apparatus System

The present invention goes beyond the concept of an individual automated Planter Apparatus by enabling each individual apparatus the ability to work in a system of a plurality of apparatuses all sharing common resource from the span electrical and water lines. FIG. 2 depicts a system composed of many Hanging Planter Apparatuses 1. A Span Control Unit 200 initiates the system span lines 206 & 207 and provides the common resources to these span lines. The SCU provides water and fertilizer to the system over the span's water feed line 206, and it provides electrical power to the system over the span's electrical feed line 207.

The SCU 200 converts the household AC electrical power 201 (120 VAC in the United States) to the low voltage DC electrical power distributed over the span's electrical feed line 207. Additionally, the SCU takes water from its connection to the local household water supply 203 and provides a control and pressure regulator function to provide a predictable water pressure the span's water feed line 206. Similarly, the SCU uses its connection to a common source of fertilizer 202 to provide nutrients to the span's water feed line 206.

The spans electrical feed line 207 is used as a transmission line for the System Communications Channel. The System Communication Channel enables all of the individual HPAs to communicate with each other and with the SCU 200. This inter-communication between apparatuses enables the system to operate reliably and efficiently. The SCU can monitor and approve or delay request for use of system resources on an individual planter basis. In this way the SCU can monitor current usage rates for the system resources and ensure that peek resource usage does not exceed the capabilities of the system. By delaying request for span resources, the SCU can spread resource request out over time. This enables a system with a large number of apparatuses to efficiently share their common resources. Since the SCU ensures that the peek resource usage does not exceed the maximum capability of the system span lines ensuring the reliability of the system. For example if the maximum power drain on the span exceeds the supply capability of the SCU's power converter, then the individual apparatuses on the span may not have sufficient electrical power to operate properly.

FIG. 20 illustrates the schematic diagram of the System Communications Channel for the Automate Planter Apparatus System given in FIG. 3. As seen in the schematic, the System Communication Channel is composed of two channels pointing in opposite directions. There is a Down-Stream Communication Channel that is originated in the SCU and transmits its communication signals in the “down-stream” direction on the system span (The SCU talks to HPA #1, HPA #1 talks to HPA #2, etc, HPA#N−1 talks to HPA#N who terminates the Down-Stream Channel.). Additionally, there is an Up-Stream Communication Channel that is terminated in the SCU and transmits its communication signals in the “up-stream” direction on the system span (HPA#N talks to HPA#N−1, etc, HPA#2 talks to HPA#1, HPA#1 talks to the SCU who terminates the Up-Stream Channel).

As seen in the schematic in FIG. 20 the HPA are connected in a series type connection rather than the parallel connection used for the DC power feed. The commands, request, and replies sent in a particular direction are forward through units and looped by the terminating unit so that all of the apparatuses on the system are aware of each other's communications. This intra-awareness on the system enables each apparatus to be aware of each other, to be aware of the current operating mode of all the other apparatuses on the system, and to be able to share results of environmental sensor reading.

The series connection of the System Communication Channel enables the apparatuses in the system to automatically determine their position in the span and to determine the total number of units operating on the span. This automatic position capability enables modifications to the span (addition or deletion of units) to be easily implemented without effort on the owner to redefine the overall system. For example, if the owner wants to add an additional HPA to the system, but wants to place it between the currently positioned HPA#2 and HPA#3. The owner would simply disconnect the span's electrical and water feed lines currently connecting HPA#2 to HPA#3. He would then connect the span lines between HPA#2's output ports to the input ports of the new HPA, then he would connect the span lines between the output ports of the new HPA to the input ports of HPA that was previously in position #3. After the new system is powered up, the new HPA would assume position #3 and the HPA that had previously been in position #3 would recognize it is now in position #4. Likewise, all HPA down stream would recognize their new position. Similarly all of the apparatuses would recognize that the total number of units had increased by 1. The SCU would also recognize the addition to the span and would recognize the new positions of all of the apparatuses.

The fact that each apparatus is able to monitor all of the other apparatuses operating mode, enables units to share common resources on a span that does not have an SCU policing the activity on the span. The HPA is also designed to operate on system with a limited number of apparatuses without the requirement for an SCU. For a system without an SCU, this capability enables the individual apparatuses to follow resource usage rules programmed into them to ensure that the system can reliably operate and efficiently use the span resources.

The System Communication Channel enables apparatuses to share individual measured results from their sensors with each other and with the SCU. This capability enables advanced trouble-shooting techniques on the system and to use advanced failure prediction techniques to track the system and provide warnings to possibly eliminate potential failures prior to an actual failure of the system.

The techniques used in providing an upstream and down-stream direction and intercommunication are similar to the techniques well documented in telecommunication networks that use similar 2-wire or 4-wire electrical span lines. An example of a 2-wire network using a similar communications channel with an up-stream and down-stream direction is the ISDN network provided by the telecom providers.

Span Control Unit

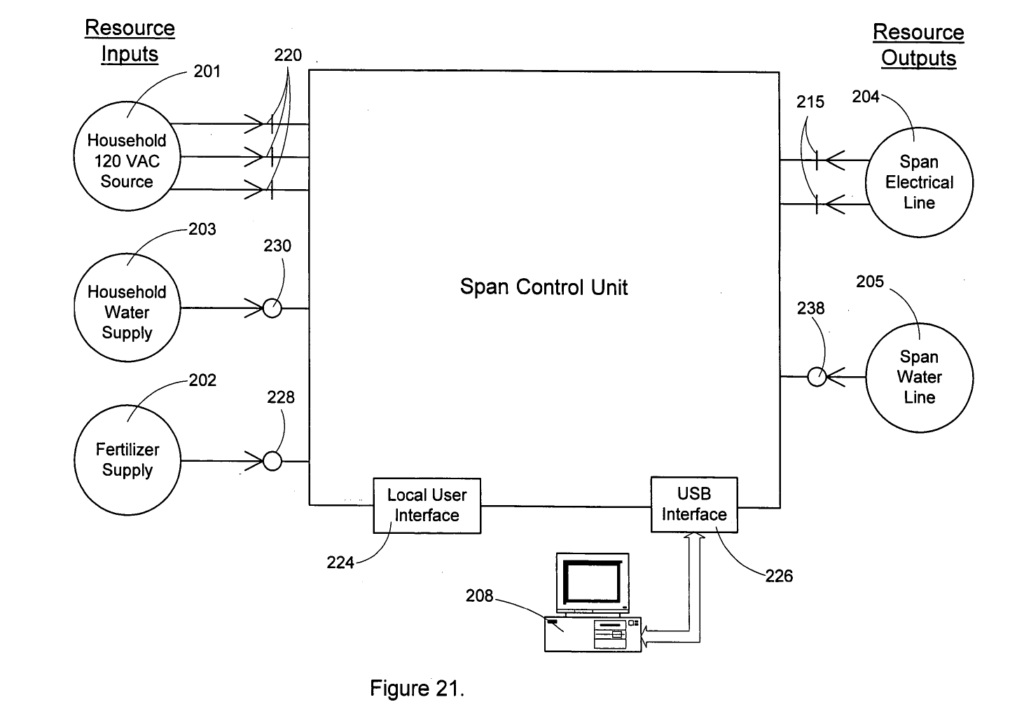

Referring now to the FIG. 21, which depicts the initial embodiment of the Span Control Unit (SCU) 200. This Span Control Unit is designed to operate in a system of Hanging Planter Apparatuses 1. As seen in FIG. 2, the SCU interfaces and initiates the system's Span Line 206 & 207. The SCU acts as a master controller of the span line while it monitors and controls the span providing electrical power, moisture, and fertilization to the HPA units in the system. The SCU communicates with each of the HPA in the system and provides an USB interface 226 for a personal computer. This PC interface is used to provide a simple human console to the span so the system's owner can easily obtain feedback on the operation of the HPA System and to provide a control interface enabling programming option settings for each HPA and enabling firmware upgrade links.

Physical Construction of SCU

The Span Control Unit 200 has three input connectors for electrical power 220, water supply 230, and fertilization supply 228. The SCU is connected to a typical household AC power source 201 (120 VAC in North America), which is used to as the source of input electrical power for the HPA System. The SCU is connected to the local household water supply 203, which is used as the water source for the HPA System. Finally, the SCU is connected to a local supply of liquid fertilizer 202, which is used for the source of fertilization for the HPA System.

The SCU has two output connectors for the HAP System Span Line 238 & 215 to provide electrical power 204 and water/fertilizer 205 to the span line to the HPAs. The SCU is connected to the input to the 2-wire electrical span line 207, which is used to provide power for each of the HPAs 1 in the system and also as the transmission channel for the System Communication Channel. The SCU is also connected to the input to the span's water feed line tubing 206, which is used to provide water and fertilizer to each of the HPAs in the system.

The SCU is designed to utilize traditional packaging of its electronics and control devices. The SCU uses PCB assembly techniques for its electronics. The PCB and control devices are then placed in a metallic or plastic housing to provide protection for the internal components and to provide compliance to the local safety standards. The housing provides connectors for the inputs and outputs to and from the SCU and provides a method to mount the SCU in its intended application. Unlike the detailed description of the packaging of the HPA given above, a complete description of the packaging of the SCU is not needed since it uses packaging methods typically used in today's market place.

Functional Block Diagram of the SCU

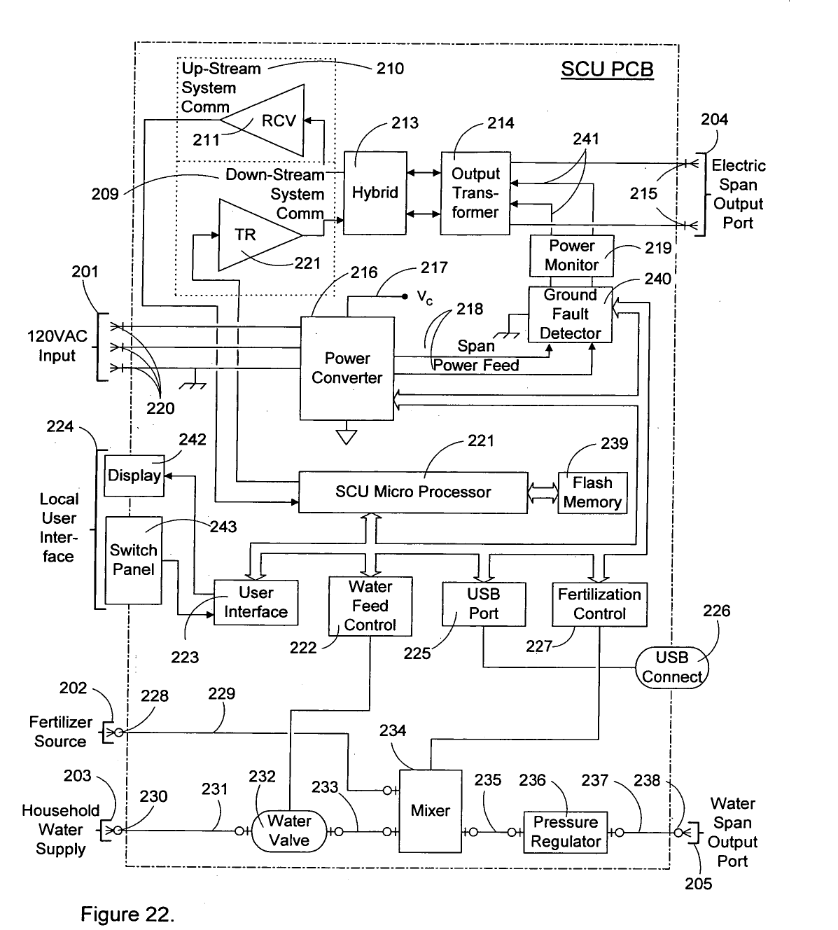

FIG. 22 gives a functional block diagram of the initial embodiment of the invention's Span Control Units electronic circuitry. The SCU electronic modules are built using typical PCB fabrication and construction techniques commonly utilized.

The SCU microprocessor provides the centralized intelligence for the system span and is responsible for the overall control of the span resources. The SCU communicates with all of the HPAs in the system over the Up-Stream and Down-Stream System Communication Channel 209 & 210. It monitors the Span Lines actual output voltage and current versus maximum limits. By communicating with the HPAs it enables or disable request from the HPA's for use of electrical power and/or the use of the span line's water and fertilizer resources.

The SCU microprocessor can interface to a personal computer through its USB interface. This PC interface enables owner of the HPA system to monitor the system from his/her PC and to use the PC as a console for programming the HPAs in the system and to monitor the various sensor readings from each of the HPAs.

The SCU microprocessor monitors the operation of each of the HPAs in the system and can aid in trouble shooting problems in the system. It can relay alarm information from the HPAs to the owner through the visual Alarm LED panel, and/or through the USB PC interface.

The SCU's power converter module 216 converts the local AC household electrical power to the low voltage DC power used as input to the system span. The power converter circuitry uses the well-documented high efficiency switch mode design techniques to perform its AC-to-DC converter function. The DC voltage output from the power converter is fed through the span voltage and current monitor circuit module 219 and through the ground fault detector module 240 before it is fed to the center taps 241 of the span line output transformer 214. The span voltage and current monitor circuit and the ground fault detector circuit enable the apparatus to meet local safety requirements on the electrical span. These circuits also enable the SCU to minimize peak demand requirements for electrical power by policing the operating modes of the HPA's units in the system.

The SCU's span line output transformer 214 isolates the DC span power feed from the power converter from the bi-directional AC signal of the System Communication Channel 209 & 210. The 2-wire electrical span line 207 is connected through the span line electrical connector 215 to the transformers primary leads, while the System Communication Channel's electronics is connected to the transformers secondary leads.

The SCU communicates on the Up-Stream 210 and Down-Stream 209 System Communications Channels using the 2-wire electrical span line 207 as a bi-directional the transmission path. Similar to the electronics of the HPA, the SCU uses a hybrid circuit 213 to isolate the bi-directional signal from the span line output transformer 214 for the transmit circuitry 212 and receive circuitry 211.

The SCU microprocessor 221 is connected to the water feed control module 222 and can use the SCU's water valve 232 as a master cut-off for the span line water feed 205. This master-cutoff valve can be used if a leak is detected in the span line or if the owner wants to temporarily turn off the water feed to the span for maintenance or other reasons. Typically this valve is “on” keeping the span water line 206 pressurized and the individual HPA watering valves 20 are used to control moisture to each HPA separately.

The fertilization control circuitry 227 is also connected to the SCU's microprocessor 221 to control the addition of fertilizer to the span lines water feed. The HPA can request fertilization and an adjustable rate of fertilization over the System Communication Channel when it places a request to enter a water cycle mode from the SCU. The SCU can then add the requested rate of fertilizer to the water fed to the water span line during the time frame of the water cycle for the HPA. The liquid fertilizer 202 is supplied to the SCU using a gravity or pressurized feed from the fertilizer supply reservoir to the SCU's mixer module 234 through input connector 228 and internal tubing 229. The SCU's mixer module 234 and fertilization control module 227 can be used to turn fertilization “on/off” and to control the rate of fertilization.

The output of the SCU's mixer module 234 is connected to the span line pressure regulator 236 through internal tubing 235. The span line pressure regulator 236 minimizes pressure variations from the household water supply 203 and provides a consistent pressure to the span line water feed 205. The output from the pressure regulator 236 is fed through internal tubing 237 to the output connector 238 for the span line water feed tubing 206.

The Local User interface 224 is accessible externally to the SCU housing and includes a display panel 242 and switch panel 243. The display panel 242 is used to indicate the current operating condition of the system span line and/or to alert the owner to detected problems on the span or with individual HPA units. The switch panel 243 is used to enable programming of operating modes and limits for the SCU when a PC is not used in the system. The SCU microprocessor 221 controls the local user interface 224 through the user interface electronic module 223.

The SCU microprocessor 221 can communicate with a personal computer tied to it USB connector 226 through the USB port electronic interface 225. This USB interface enables the pc to become a console that can be used to program the operation of the SCU and each of the HPAs. The programming for the control of the individual HPAs can be more involved and sophisticated than the simpler programming setup by the HPA's switch panel 157 in the HPA's user interface 155. As such, the switch panel can be used on small systems that do not require the use of an SCU. However, larger systems that have an SCU controlling the span and a pc connected to the SCU can benefit through the use of more sophisticated programming.

The USB connection to the pc can also be used to provide firmware upgrade for the SCU microprocessor. The firmware for the SCU microprocessor is stored in flash memory 239. If a firmware upgrade is desired for the SCU to add performance features or to resolve older firmware issues, the pc can download the firmware upgrade through the USB port 225 to the SCU microprocessor 221. The SCU microprocessor can then save the new firmware upgrade into its flash memory module 239. Similarly, firmware upgrades for HPAs can be downloaded from the pc to the SCU through the USB port; the SCU can then transmit the upgrade to the HPA units through the electrical span line 207 and the System Communications Channel.

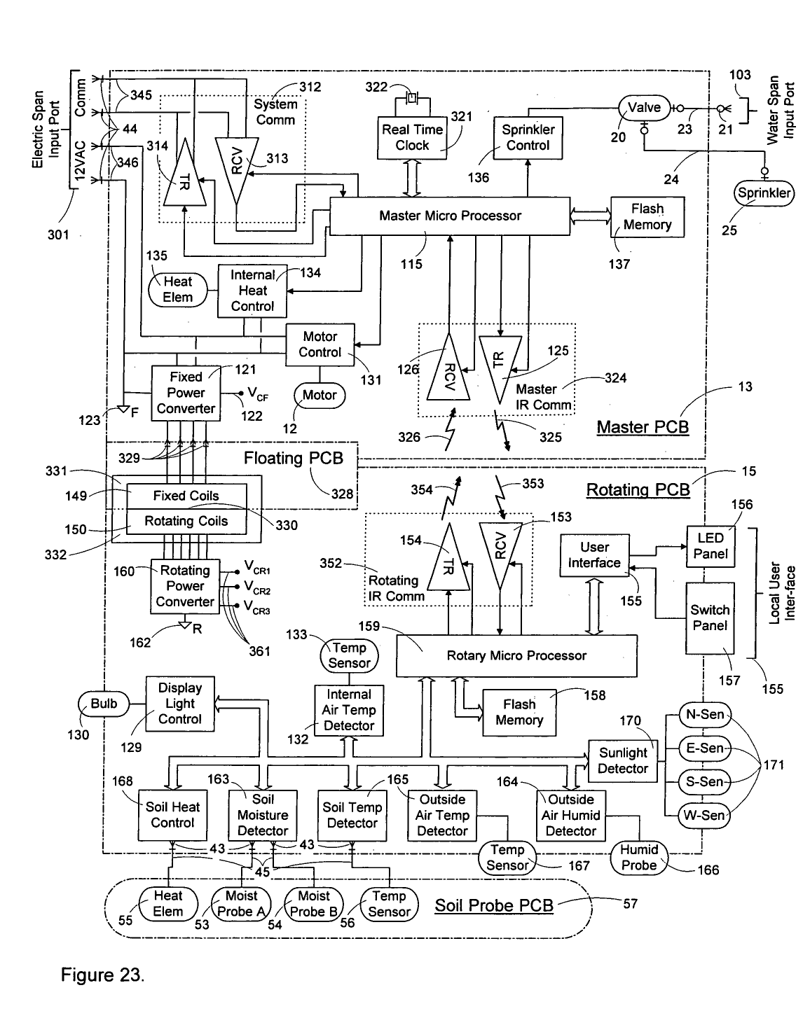

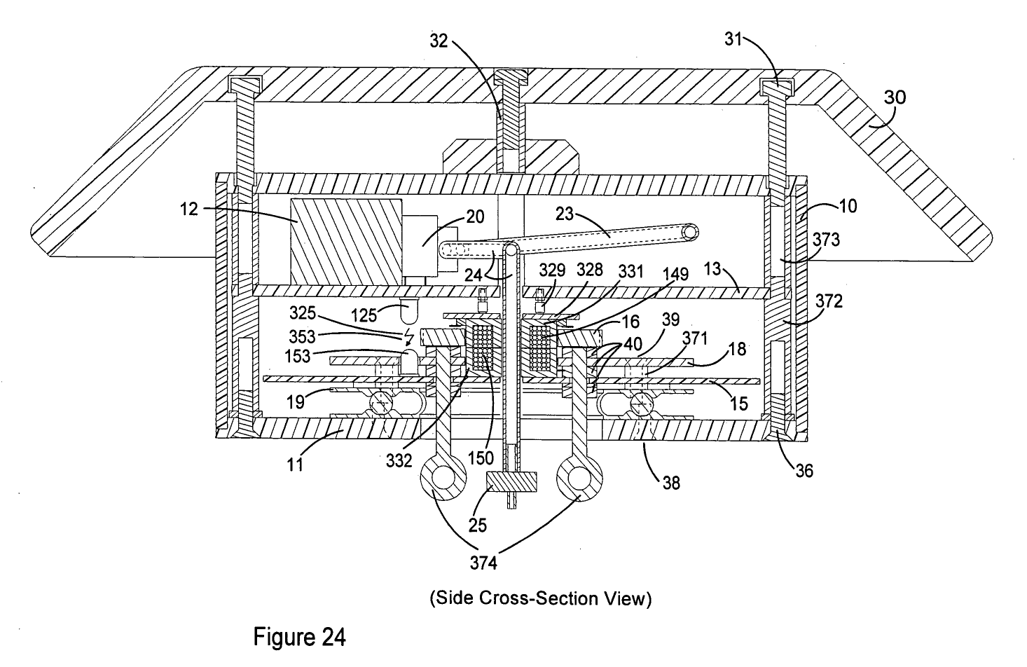

Referring now to FIGS. 23-26, there is shown another embodiment of a planter apparatus in accordance with the invention. FIG. 23 is a block diagram of an alternate electronic circuitry and the Overhead Modules mechanical construction of the alternate design is illustrated in FIG. 24. The alternate block diagram in FIG. 23 can be compared to the original electronic block diagram given in FIG. 19. Comparing the two one can see that both perform virtually identical functions for the PA. There are however changes in the implementation of the electronic circuitry between the two electronic Block Diagrams.

The changes in the alternate electronic circuitry include the following six overall changes.
1) Four-Wire Span Line: The Span Line electrical distribution channel for the PA System is changed from a 2-wire circuit 207 to a 4-wire circuit 307.
2) System Communication channel: The System Communication Channel is changed from an architecture based on series elements to one based on parallel elements.
3) Rotating Channel IR Link: The Rotating Communication Channel implementation is changed to utilize an IR channel link rather than using the Rotating Transformer for the channel's distribution link.
4) Rotating Transformer: The design of the Rotating Transformer 330 utilizes standard ferrite pot core construction techniques to ensure efficient power transfer between the Master PCB 13 to the Rotating PCB 15.
5) Real Time Clock: Addition of a Real Time Clock interface circuit module 322 to the Master PCB 13 that is readable by the Master Microprocessor 115.
6) PCB Electronic Module Allocation: The following electronic modules: the Display Light Bulb 130, the Display Light Control electronics module 129, the internal air temperature sensor 133, and the internal air temperature electronic module 132 are all moved from the Master PCB 13 to the Rotating PCB 15.
   These changes in the alternate design are described in further detail in corresponding sections below.

FIG. 24 shows the construction of an alternate overhead module. When FIG. 24 is compared to the Overhead Module of FIG. 7, it should be noted that while the actual implementation of the two designs show minor differences both designs perform virtually identical functions. The Overhead modules housing shown in FIG. 24 can be constructed using commonly available sheet and tubing stock. This construction technique is utilized for preliminary low volume production units; avoiding the tooling cost for custom housing details.

Preferably, the housing 10 is constructed from acrylic tubing and sheet stock and by using metallic threaded stand-offs and fasteners for support and assembly. The Master PCB is held to the housing using metallic threaded female-to-female stand-offs 373, metallic threaded male-to-female stand-offs 372, and Shoulder Head Screws 31. The Base Plate Sub-Assembly is held to the housing using metallic threaded male-to-female stand-offs 372, and Base Plate to Housing Screws 36.

Three threaded nuts 40 are used to attach each of four threaded eyebolts 374 into the Rotating Module Sub-Assembly. These nuts and bolts are used to hold the Rotating Mounting Plate and Rotating PCB together. The support ligaments 29 for the soil container clip into the eye of the eyebolts 374. The rotating mounting plate 18 is attached to the lazy susan bearing 19 using stand-offs 371 and screws 39. The lazy susan bearing 19 thus supports the weight of the soil container that is hanging on the eyebolts 371 through the support of the rotating mounting plate 18.

It should be noted that another embodiment of the rotating transformer 330 is also illustrated in FIG. 24. Note that the Rotating Transformer centerline is placed onto the centerline for the PA housing and rotating mechanism. In this manner, as the PA's drive motor 12 rotates the Rotating Sub-Assembly, the Rotating Coils 150 rotate on a center line equal to the center line of the Fixed Coils 149 and power is properly transferred to the Rotating PCB 15. The Rotating Coils 150 are attached inside the rotating half of the transformer's ferrite pot core 332 and they are then both secured onto the Rotating PCB on its centerline. The Fixed Coils 149 are similarly attached inside the fixed half of the transformer's ferrite pot core 331 and they are secured onto the Floating PCB 328.

Note that the hole in the center of the Rotating Transformer Pot Core 331 & 332 and the center holes in the Rotating PCB 15, Floating PCB 328, and Master PCB 13 enable the water line 24 for the planter's sprinkler 25 to exit the housing without being twisted.

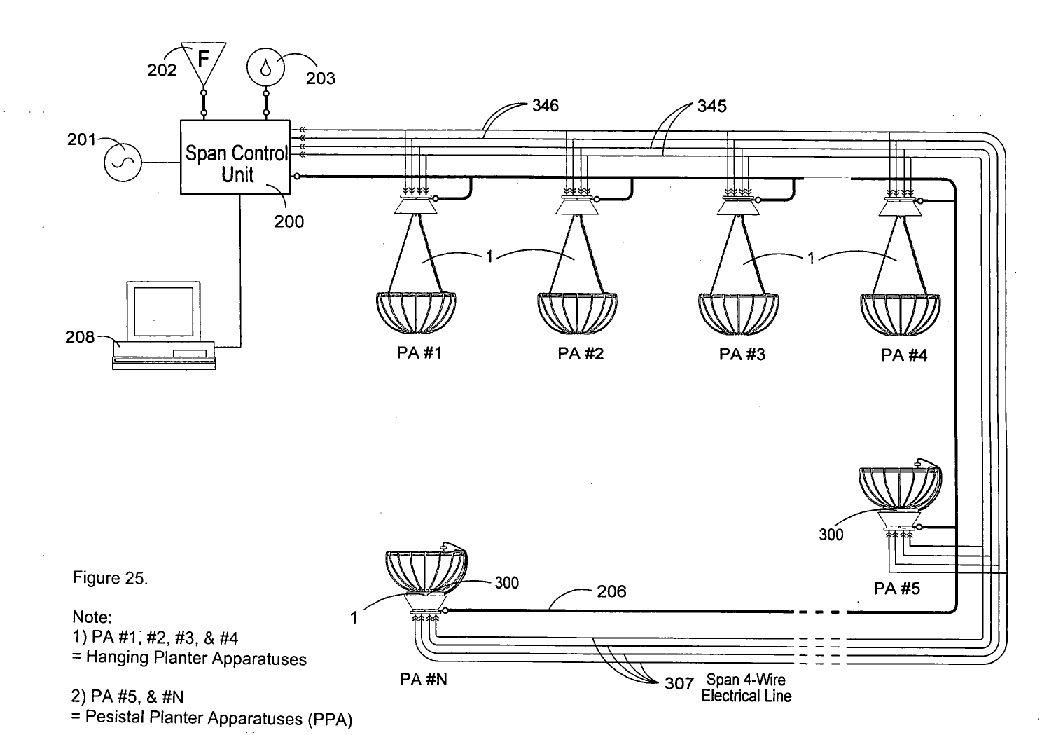

FIG. 25 illustrates another embodiment for a System of Automated Planter Apparatuses. Note that the Electrical Span Line is a 4-Wire circuit and the PA units are connected in a parallel configuration as compared to the system illustrated in FIG. 2. The system shown in FIG. 25 illustrates that the system can operate with several types of PA. The system illustrated in FIG. 25 shows another embodiment for the planter apparatus 300. The pedestal planter apparatus (PPA) 300 is virtually identical to the hanging embodiment except the soil container rests on a rotating platform of a housing module rather than hanging from the Overhead module.

Changes of the alternate design of the PA are further detailed below.

1) Four-Wire Span Line: The Electronic Span Line for the PA described in FIG. 23 uses a 4-wire Span Line 307 rather than the 2-wire Span Line. In the alternate configuration given in FIG. 23, the PA utilizes two separate 2-wire pairs. One 2-Wire pair is used for power distribution across the Span Line 346, and a separate 2-Wire pair 345 is used for the system communication channels signal distribution. The benefit of the alternate 4-wire span is that it simplifies and reduces the electronics in the Overhead Module 2. The alternate configuration eliminates the requirement for input and output transformers 110 and 120 and hybrid circuits 111 and 119 to split the combined power signal and communication signals off of the 2-wire distribution channel.

Further, the PA built with the electronics depicted in FIG. 23 is connected together in a system utilizing a true parallel connection scheme rather than a series fashion. The parallel connection enhances the reliability of the span distribution circuit. The parallel feed connection scheme reliability is improved, by eliminating possible single point of failure modes.

The embodiment shown in FIG. 25 has a single electrical span input connector 44 that has 4 contacts to connect the PA to the 4-wire span line. The embodiment shown in FIGS. 2-19 original electronic solution utilized two separate connectors 44 and 49 for separate connections to an input port 101 for a 2-wire span line and an output port 102 for a separate 2-wire span line. Similarly, FIG. 23 shows that the alternate configuration has a single input port 21 for the span tubing utilized to distribute water and fertilizer 206.

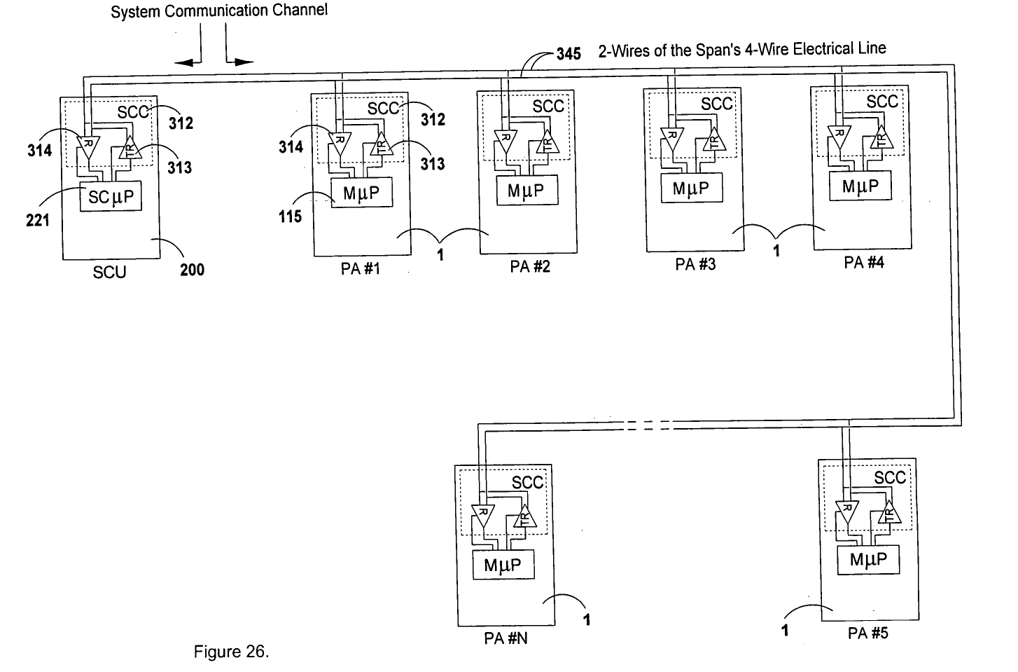

2) System Communication channel: The System Communication Channel is changed from an architecture based on series elements to one based on parallel elements, as illustrated in the schematic diagram shown in FIG. 26. Note that it uses a single parallel connection 2-wire distribution channel for both directions of communication. Also, note that all of the unit's receivers on the system receive the transmission from any transmitter broadcasting on the 2-wire line.

In the series based communication channel illustrated in FIG. 20, the span communication channel is split into a down-stream channel 112 and a separate up-stream channel 116. This series element approach enables the system to automatically assign a sequential ID number to each unit on the system based on their relative location on the span.

In the system communication design illustrated in FIG. 26, a bi-directional System Communication Channel that uses parallel element architecture is used. Multiple transmitters are placed on a common 2-wire bus. Similarly, multiple receivers are also placed on the same common 2-wire bus.

The communication channel 312 of FIG. 26 can be implemented using standard TIA/EIA-485 differential transceivers 313 and 314. The TIA/EIA-485 standard enables multiple drivers to share a common 2-wire balanced transmission line. The devices are all connected in parallel to the distribution line in a multi-point configuration. This simple system communication channel solution enable all devices tied to communicate to all others devices tied to the 2-wire distribution line to communicate with each other.

The transmitters are placed in a high impedance state when they are not transmitting. The protocol of the communication channel ensures that only one transmitter is allowed to talk at any time.

With the system communication channel of FIG. 26, the unit ID and location information can be obtained either manually from the user, or automatically using sensor feedback and/or software algorithms.

3) Rotating Channel IR Link: The electronic schematic shown in FIG. 23 utilizes an IR channel link. The Rotating Communication Channel enables the Master Microprocessor 115 on the Master PCB 13 to communicate with the Rotary Microprocessor 159 on the Rotating PCB 15. In the original PA electronic block diagram given in FIG. 19, the Rotating Transformer was utilized to provide a distribution path between the two microprocessors. This implementation change simplifies the electronic schematic by eliminating the hybrids 128 & 151 and power oscillator 127 in the original implementation.

Identical IR transmitting and receiving circuit pairs are utilized for the transmit channel 125 and the receive channel 126 on the Master PCB 13 the transmit channel 154 and the receive channel 153 on the Rotating PCB 15. The Master Microprocessor 115 sends a message for the Rotating Microprocessor 159 through the Master IR Communication Channel's 324 Transmitter 125. The IR field 325 generated by the Master IR Transmitter 125 illuminates the rotating IR receiver 153. This received IR illumination field 353 is coupled into the Rotating IR Channel's 352 Receiver 153 and can be read by the Rotating Microprocessor 159.

Likewise the Rotating Microprocessor 159 sends a message to the Master Microprocessor 115 through the Rotating IR Channel 352 Transmitter 154 to generate an IR illumination 354 pointed to the Master IR channel's 324 Receiver 126. The IR illumination field 326 is coupled into the Master IR channel's Receiver 126 and can be read by the Master Microprocessor 115.

The Master IR Transmitter 125 and IR Receiver 126 are located on the bottom side of the Master PCB 13 so their IR windows point toward the topside of the Rotating PCB 15. Likewise, the Rotating IR Transmitter 154 and IR Receiver 153 are located on the topside of the Rotating PCB 15 so their IR windows point toward the bottom side of the Master PCB 13. In this manner, the Master IR Transmitter's IR field 325 illuminates the Rotating IR Receiver's IR Input field 353. By placing the IR transmitters and IR receivers on both PCBs on a circle with a common radius about the centerline of the PA, and by using multiple transmitters and receivers on each PCB, a circular IR link is established. This circular IR link enables the two microprocessors to communicate independent of the angular position between the two PCBs and independent of weather the apparatus is currently rotating the planter or not.

4) Rotating Transformer: The Rotating Transformer's 330 design implementation ensures that it provides efficient electrical power transfer between the Master PCB to the Rotating PCB 15. The construction of the rotating transformer 330 shown in FIG. 23 is illustrated in the cross sectional view of the Over Head Module, FIG. 24. The Rotating Transformer is constructed using a round ferrite core halves. The two ferrite core halves 331 and 332 are used to concentrate and direct the magnetic flux of the transformer. In this manner the transformer is designed and constructed using well-established design methods for pot-core type transformers.

The rotating transformer of this design diverts from the conventional construction by separating the transformers fixed coils 149 from the rotating coils 150. The fixed coils are wound onto a one-half height bobbin and the rotating coils are wound onto a separate one-half height bobbin. Each of the separate half height bobbins is inserted into separate halves of the ferrite pot core.

As seen in FIG. 24 when the two halves of the Rotating Transformer are installed into the Overhead Module, the two halves are aligned onto a common centerline axis and are held in a vertical position that ensures the two halves are in contact with each other. Since the coils are concentric around the centerline axis and the pot core ferrite is round, the electromagnetic field coupled between the transformer halves will not vary if the rotating coil and ferrite half is rotated about the center axis with respect to the fixed coil and ferrite half.

The fixed half of the rotating transformer is mounted on the Floating PCB 328 and includes the fixed half of the ferrite core 331 and the fixed coils 149. The floating PCB is connected to the Master PCB 13 through spring connectors 329. These spring connectors 329 enable the Floating PCB 328 to be positioned horizontally below the Master PCB 13 by a variable distance determined by the operating range of the springs 329. This variable distance ensures that when the Rotating PCB 15 is mounted into the Overhead Module 2, the ferrite 331 of the fixed half 149 of the rotating transformer is in contact with the ferrite 332 of the rotating half 150 of the rotating transformer. The spring connectors 329 are positioned between the two PCBs so they keep the two halves of the rotating transformer 330 under the compression force of the springs pushing the two parts together.

Without the spring contacts 329 the typical manufacturing tolerance stack-up could cause the vertical distance between the two halves of the transformer to vary after assembly. This vertical distance variation will cause a misalignment between the two coils of the rotating transformer. This misalignment could severely impact the coupling between two coils and severely impact the ability of the rotating transformer to operate properly. The spring connectors 329 are used to over come this potential misalignment and ensure the ferrite halves of the rotating transformer are in contact with each other.

The rotating transformer is used in a standard switching power supply circuit that takes 12 VAC from the Span Line Input port and generates the DC Supply voltages needed to power all of the electronics on both the Master PCB 13 and the Rotating PCB 15. The switching power supply control IC is located on the Master PCB in the Fixed Power Converter module 121. The Fixed Power Converter module generates a high frequency PWM waveform that is driven into a driving coil in the Fixed Coil 149 half of the Rotating Transformer. An output from the Fixed Power Converter 121 module is V_{CF} 122, which is a DC Supply voltage used to power the electronics on the Master PCB 13. This output is generated from power received in a separate receive coil also in the fixed coil half 149 of the Rotating Transformer 330. The Fixed Power Converter uses a standard feedback circuit to monitor the amplitude of V_{CF} and controls the PWM waveform driven into the driving coil to generate the desired output voltage V_{CF} 122.

Similarly, the coils in the Rotating Coils 150 of the Rotating Transformer receive power from their coupling to the driving coil in the Fixed Coils 149. The turns ratio between the fixed driving coil and any rotating receive coil can be set so that when the switching power supply regulates V_{CF}, the output from the other receive coil in the transformer is also regulated to the desired level. In this manner, there are three receive coils placed in the rotating coil 150 half of the rotating transformer to generate three separate output voltages from the Rotating Power Converter 160 on the Rotating PCB 15. These three output voltages V_{CR1}, V_{CR2}, and V_{CR3} 161 are used to power the electronics on the Rotating PCB 15. One of the output voltages is used to power the digital circuitry, and the other two voltages are positive and negative voltages used to power the analog circuitry on the PCB. The three output voltages 161 are converted from the output of three separate coils in the rotating half 150 of the rotating transformer 330. The number of turns for each of these coils is set by the turns ratio needed to generate the desired output voltage.

5) Real Time Clock: The electronic schematic shown in FIG. 23 indicates the addition of a Real Time Clock interface circuit module 321 to the Master PCB 13. The real time clock interface module 321 gives the PA 1 the additional knowledge of absolute time. The Real Time Clock module is readable and programmable through the Master Microprocessor 115. The Real Time clock is initially set for the current time and date at installation. The Real Time Clock module 321 can include a battery back-up 322 so that the PA does not loose its real time setting if the power is temporarily lost to the system Span Line 307. The PA's knowledge of real time and date simplifies record keeping of the sensor readings and simplifies comparison of data measured by different planters. An additional benefit of this knowledge of real time is that the PA can be optionally programmed to follow local water restrictions.

6) PCB Electronic Module Allocation: The electronic schematic of the PA shown in FIG. 23 moves several circuit modules from the Master PCB 13 to the Rotating PCB 15: The Display Light Bulb 130 and the Display Light Control electronics module 129 are moved to the rotating PCB. This enables the Light Bulb 130 to exit the Overhead module through the user interface located in the center opening of the Overhead module housing. This placement position of the bulb provides optimal illumination of the planter hanging below plus it simplifies the installation of the bulb and socket. The internal air temperature sensor 133, and the internal air temperature electronic module 132 are moved to the Rotating PCB 15 so they can use a common Analog to Digital electronic circuit used by the outside air and soil temperature detectors.

Of course, it should be understood that the order of the steps and/or acts of the algorithms discussed herein may be accomplished in different order depending on the preferences of those skilled in the art. Furthermore, though the invention has been described with respect to a specific preferred embodiment, many variations and modifications will become apparent to those skilled in the art upon reading the present application.

1. A hanging plant planter apparatus comprising:
a container adapted to be suspended and adapted for containing soil and a plant planted in the soil;
at least one sensor for monitoring at least one growing condition parameter and generating a growing condition parameter signal;
a controller for controlling the at least one growing condition in response to the growing condition parameter signal; and
an effector coupled to and controlled by the controller for controlling at least one of the following growing conditions: water, temperature, fertilization, illumination, and plant orientation.

2. A hanging plant planter apparatus as claimed in claim 1 wherein the controller further has an input for receiving an indication corresponding to a species of the plant planted in the container and wherein the controller further controls the at least one growing condition based on the plant species.

3. A hanging plant planter apparatus as claimed in claim 1 further comprising an overhead housing from which the container is suspended wherein the controller is located in the overhead housing.

4. A hanging plant planter apparatus as claimed in claim 1 wherein the sensor measures moisture in the soil and the effector is controlled to provide desired levels of water to the soil.

5. A hanging plant planter apparatus as claimed in claim 1 wherein the sensor measures soil temperature and the effector is controlled to maintain a desired soil temperature.

6. A hanging plant planter apparatus as claimed in claim 1 wherein the sensor monitors fertilization in the soil and the effector is controlled to provide desired levels of fertilizer to the soil.

7. A hanging plant planter apparatus as claimed in claim 1 wherein the sensor monitors the temperature of the air immediate to the plant.

8. A hanging plant planter apparatus as claimed in claim 1 wherein the sensor monitors humidity of the air immediate to the plant.

9. A hanging plant planter apparatus as claimed in claim 1 wherein the sensor monitors illumination exposure and the effector is controlled to provide uniform illumination of light to the various sides of the plant.

10. A hanging plant planter apparatus as claimed in claim 1 wherein controller includes an input interface to allow a user to input information about the particular type of plant being housed in the container and wherein the controller utilizes this information for controlling the at least one growing condition.

11. A hanging plant planter apparatus as claimed in claim 1 wherein the at least one sensor comprises two or more sensors for measuring at least two of the following: moisture in the soil, temperature, fertilization, and illumination.

12. A hanging plant planter apparatus as claimed in claim 3 wherein the overhead housing houses a drive mechanism for rotating the container and wherein the sensor detects plant orientation with respect to a light source and the drive mechanism is controlled to effectuate angular position of the plant with respect to the light source.

13. A hanging plant planter apparatus as claimed in claim 12 wherein the overhead housing includes a first portion and a second portion, with the second portion being driven in rotation relative to the first portion, and with the container suspended from the second portion.

14. A hanging plant planter apparatus as claimed in claim 1 wherein the controller uses current information provided from the sensor to effect control.

15. A hanging plant planter apparatus as claimed in claim 14 wherein the controller uses current information and historical information provided from the sensor to effect control.

16. A plant planter system comprising:
a plurality of planters each having a container adapted for containing soil and a plant planted in the soil, each planter further comprising:
at least one sensor for monitoring at least one growing condition parameter and generating a growing condition parameter signal;
a planter controller in communication with the sensor for receiving the growing condition parameter signal and adapted for controlling the at least one growing condition in response to the growing condition parameter signal; and
an effector in communication with and controlled by the planter controller for controlling at least one growing condition;
a resource supply coupled to each of the planters for providing resources needed for effecting the at least one growing condition; and
a system controller in communication with each of the planter controllers and adapted for controlling the resource supply for selectively allocating resources from the resource supply to the planters responsive to requests received from the planter controllers, wherein the system controller determines when to allocate a resource based on status conditions of the resource.

17. A plant planter system as claimed in claim 16 wherein the resource supply includes at least one of a water supply, a fertilizer supply, and an electric supply.

18. A plant planter system as claimed in claim 17 wherein the system controller enables regulator functionality to the water supply for providing a predictable water pressure to the planters.

19. A plant planter system as claimed in claim 18 wherein the system controller enables application of fertilizer from the fertilizer supply to the planters via the water supply.

20. A plant planter system as claimed in claim 17 wherein the system controller monitors total system power and allocates power from the electric supply to the planters in a manner to ensure that a maximum power level of the electric supply is not exceeded.

21. A plant planter system as claimed in claim 16 wherein at least one of the plurality of planters is a pedestal planter wherein the container is adapted to be supported on a pedestal base and wherein the planter controller is located in the pedestal base, and wherein at lest one of the plurality of planters is a hanging planter wherein the container is adapted to be suspended from an overhead housing and wherein the planter controller is located in the overhead housing.

22. A plant planter apparatus comprising:
a container adapted for containing soil and a plant planted in the soil;
at least one sensor for determining a status of at least one growing condition parameter and responsive thereto for generating a corresponding status signal;
a controller in communication with the at least one sensor for receiving the status signal and responsive thereto for determining a growing condition response for managing the health of the plant; and wherein
the controller further has an input for receiving an indication corresponding to a species of the plant planted in the container and wherein the controller determines a growing condition response based on the plant species; and
an effector in communication with the controller and responsive to the growing condition response for effecting at least one of the following growing condition parameters: soil moisture content, soil temperature, soil fertilization, plant illumination, and plant orientation.

23. A plant planter apparatus as claimed in claim 22 wherein the container is adapted to be supported on a pedestal base and wherein the controller is located in the pedestal base.

24. A plant planter apparatus as claimed in claim 23 further including a drive mechanism located with the pedestal base and in rotational communication with the container for rotating the plant about an axis.

25. A plant planter apparatus as claimed in claim 22 wherein the sensor determines moisture content of the soil and the effector effectuates delivery to the soil of an amount of water determined by the controller.

26. A plant planter apparatus as claimed in claim 22 wherein the sensor measures soil temperature and the effector effectuates delivery to the soil of an amount of heat determined by the controller.

27. A plant planter apparatus as claimed in claim 22, wherein the sensor measures one of humidity and temperature of air immediate to the plant.

28. A plant planter apparatus as claimed in claim 22 wherein the sensor measures fertilization level of the soil and the effector effectuates delivery to the soil of an amount of fertilizer determined by the controller.

29. A plant planter apparatus as claimed in claim 22 wherein the sensor determines plant orientation with respect to an illumination source and the effector effectuates angular positioning of the plant with respect to the illumination source.

30. A plant planter apparatus as claimed in claim 22 wherein the controller includes a memory adapted for storing growing condition parameter information corresponding to received status signals whereby the controller considers both historic information and current information for determining a growing condition response.

31. A plant planter apparatus as claimed in claim 22 wherein the sensor comprises two or more sensors for determining at least two of the growing condition parameters.
